(19) United States
(12) Patent Application Publication
(10) Pub. No.: US 2024/0049252 A1
(43) Pub. Date: Feb. 8, 2024

(54) SIDELINK-BASED CROSS-LINK INTERFERENCE MEASUREMENTS

(71) Applicant: QUALCOMM Incorporated, San Diego, CA (US)

(72) Inventors: Kapil GULATI, Belle Mead, NJ (US); Navid ABEDINI, Basking Ridge, NJ (US); Sony AKKARAKARAN, Poway, CA (US); Junyi LI, Fairless Hills, PA (US); Shuanshuan WU, San Diego, CA (US); Anantharaman BALASUBRAMANIAN, San Diego, CA (US); Sourjya DUTTA, San Diego, CA (US); Hui GUO, Beijing (CN)

(21) Appl. No.: 18/255,966

(22) PCT Filed: Feb. 26, 2021
(86) PCT No.: PCT/CN21/78110

§ 371 Date: Jun. 5, 2023

(51) Int. Cl. H04W 72/25; H04W 72/40; H04B 7/06

(52) U.S. Cl. CPC H04W 72/25; H04W 72/40; H04B 7/06968

(57) ABSTRACT

Certain aspects of the present disclosure provide techniques for facilitating sidelink (LS) cross-link interference (CLI) measurements within a wireless communication network. A method that may be performed by a second UE includes receiving a sidelink (SL) cross-link interference (CLI) configuration from a second base station indicating resources for performing the SL CLI measurements, performing the SL CLI measurements on the resources indicated in the SL CLI configuration, and transmitting a report to the second base station indicating the SL CLI measurements.

### INTRODUCTION

Aspects of the present disclosure relate to wireless communications, and more particularly, to techniques for improving sidelink (SL)-based cross-link interference (CLI) measurements in wireless communication systems.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, challenges may include the performing cross-link interference (CLI) measurements in wireless communication systems. Consequently, there exists a need for further improvements in wireless communications systems to overcome various challenges.

### SUMMARY

Certain aspects provide a method for wireless communications by a first user equipment (UE). The method generally includes transmitting signaling to a first base station including: a request for resources to transmit one or more sidelink (SL) transmissions and an indication regarding a first SL transmission beam that the UE intends to use to transmit the one or more SL transmissions, receiving a grant for the resources to transmit the one or more SL transmissions, wherein the grant provides an indication regarding a second SL transmission beam to use for transmitting the one or more SL transmissions, and transmitting the one or more SL transmissions on the granted resources using the second SL transmission beam.

Certain aspects provide a first user equipment (UE). The first UE generally includes means for transmitting signaling to a first base station including: a request for resources to transmit one or more sidelink (SL) transmissions and an indication regarding a first SL transmission beam that the UE intends to use to transmit the one or more SL transmissions, means for receiving a grant for the resources to transmit the one or more SL transmissions, wherein the grant provides an indication regarding a second SL transmission beam to use for transmitting the one or more SL transmissions, and means for transmitting the one or more SL transmissions on the granted resources using the second SL transmission beam.

Certain aspects provide a first user equipment (UE). The first UE generally includes a transceiver configured to transmit signaling to a first base station including: a request for resources to transmit one or more sidelink (SL) transmissions and an indication regarding a first SL transmission beam that the UE intends to use to transmit the one or more SL transmissions, receive a grant for the resources to transmit the one or more SL transmissions, wherein the grant provides an indication regarding a second SL transmission beam to use for transmitting the one or more SL transmissions, and transmit the one or more SL transmissions on the granted resources using the second SL transmission beam.

Certain aspects provide an apparatus for wireless communications by a first user equipment (UE). The apparatus generally includes a first interface configured to output signaling for transmission to a first base station including: a request for resources to transmit one or more sidelink (SL) transmissions and an indication regarding a first SL transmission beam that the UE intends to use to transmit the one or more SL transmissions. The apparatus may also include a second interface configured to receive a grant for the resources to transmit the one or more SL transmissions, wherein the grant provides an indication regarding a second SL transmission beam to use for transmitting the one or more SL transmissions. In some cases, the first interface may be further configured to output the one or more SL transmissions for transmission on the granted resources using the second SL transmission beam.

Certain aspects provide a computer-readable medium for wireless communications. The computer-readable medium includes codes executable to transmit signaling to a first base station including: a request for resources to transmit one or more sidelink (SL) transmissions and an indication regarding a first SL transmission beam that the UE intends to use to transmit the one or more SL transmissions, receive a grant for the resources to transmit the one or more SL transmissions, wherein the grant provides an indication regarding a second SL transmission beam to use for transmitting the one or more SL transmissions, and transmit the one or more SL transmissions on the granted resources using the second SL transmission beam.

Certain aspects provide a method for wireless communications by a first base station (BS). The method generally includes receiving signaling from a first user equipment (UE) including: a request for resources to transmit one or more sidelink (SL) transmissions and an indication regarding a first SL transmission beam that the UE intends to use to transmit the one or more SL transmissions, transmitting a grant for the resources to transmit the one or more SL transmissions, wherein the grant provides an indication regarding a second SL transmission beam to use for transmitting the one or more SL transmissions, and transmitting signaling to a second base station indicating the resources for use by the first UE for transmitting the one or more SL transmissions.

Certain aspects provide a first base station (BS). The first BS generally includes means for receiving signaling from a first user equipment (UE) including: a request for resources to transmit one or more sidelink (SL) transmissions and an indication regarding a first SL transmission beam that the UE intends to use to transmit the one or more SL transmissions, means for transmitting a grant for the resources to transmit the one or more SL transmissions, wherein the grant provides an indication regarding a second SL transmission beam to use for transmitting the one or more SL transmissions, and means for transmitting signaling to a second base station indicating the resources for use by the first UE for transmitting the one or more SL transmissions.

Certain aspects provide a first base station (BS). The first BS generally includes a transceiver configured to receive signaling from a first user equipment (UE) including: a request for resources to transmit one or more sidelink (SL) transmissions and an indication regarding a first SL transmission beam that the UE intends to use to transmit the one or more SL transmissions, transmit a grant for the resources to transmit the one or more SL transmissions, wherein the grant provides an indication regarding a second SL transmission beam to use for transmitting the one or more SL transmissions, and transmit signaling to a second base station indicating the resources for use by the first UE for transmitting the one or more SL transmissions.

Certain aspects provide an apparatus for wireless communications by a first base station (BS). The apparatus generally includes a first interface configured to receive signaling from a first user equipment (UE) including: a request for resources to transmit one or more sidelink (SL) transmissions and an indication regarding a first SL transmission beam that the UE intends to use to transmit the one or more SL transmissions. The first BS may also include a second interface configured to output, for transmission to the first UE, a grant for the resources to transmit the one or more SL transmissions, wherein the grant provides an indication regarding a second SL transmission beam to use for transmitting the one or more SL transmissions. Additionally, in some cases, the second interface may be further configured to output signaling for transmission to a second base station indicating the resources for use by the first UE for transmitting the one or more SL transmissions.

Certain aspects provide a computer-readable medium for wireless communications. The computer-readable medium includes codes executable to receive signaling from a first user equipment (UE) including: a request for resources to transmit one or more sidelink (SL) transmissions and an indication regarding a first SL transmission beam that the UE intends to use to transmit the one or more SL transmissions, transmit a grant for the resources to transmit the one or more SL transmissions, wherein the grant provides an indication regarding a second SL transmission beam to use for transmitting the one or more SL transmissions, and transmit signaling to a second base station indicating the resources for use by the first UE for transmitting the one or more SL transmissions.

Certain aspects provide a method for wireless communications by a second base station (BS). The method generally includes receiving signaling from a first base station indicating resources for use by a first UE, associated with the first base station, for transmitting one or more SL transmissions, transmitting, based on the signaling from the first base station, a sidelink (SL) cross-link interference (CLI) configuration to a second UE associated with the second BS indicating resources for performing SL CLI measurements on the resources used by the first UE for transmitting one or more SL transmissions, and receiving the SL CLI measurements from the second UE.

Certain aspects provide a second base station (BS). The second BS generally includes means for receiving signaling from a first base station indicating resources for use by a first UE, associated with the first base station, for transmitting one or more SL transmissions, means for transmitting, based on the signaling from the first base station, a sidelink (SL) cross-link interference (CLI) configuration to a second UE associated with the second BS indicating resources for performing SL CLI measurements on the resources used by the first UE for transmitting one or more SL transmissions, and means for receiving the SL CLI measurements from the second UE.

Certain aspects provide a second base station (BS). The second BS generally includes a transceiver configured to receive signaling from a first base station indicating resources for use by a first UE, associated with the first base station, for transmitting one or more SL transmissions, transmit, based on the signaling from the first base station, a sidelink (SL) cross-link interference (CLI) configuration to a second UE associated with the second BS indicating resources for performing SL CLI measurements on the resources used by the first UE for transmitting one or more SL transmissions, and receive the SL CLI measurements from the second UE.

Certain aspects provide an apparatus for wireless communications by a second base station (BS). The apparatus generally includes a first interface configured to receive signaling from a first base station indicating resources for use by a first UE, associated with the first base station, for transmitting one or more SL transmissions. The apparatus may also include a second interface configured to output, based on the signaling from the first base station, a sidelink (SL) cross-link interference (CLI) configuration for transmission to a second UE associated with the second BS indicating resources for performing SL CLI measurements on the resources used by the first UE for transmitting one or more SL transmissions. Further, in some cases, the first interface may be further configured to receive the SL CLI measurements from the second UE.

Certain aspects provide a computer-readable medium for wireless communications. The computer-readable medium includes codes executable to receive signaling from a first base station indicating resources for use by a first UE, associated with the first base station, for transmitting one or more SL transmissions, transmit, based on the signaling from the first base station, a sidelink (SL) cross-link interference (CLI) configuration to a second UE associated with the second BS indicating resources for performing SL CLI measurements on the resources used by the first UE for transmitting one or more SL transmissions, and receive the SL CLI measurements from the second UE.

Certain aspects provide a method for wireless communications by a second user equipment (UE). The method generally includes receiving a sidelink (SL) cross-link interference (CLI) configuration from a second base station indicating resources for performing the SL CLI measurements, performing the SL CLI measurements on the resources indicated in the SL CLI configuration, and transmitting a report to the second base station indicating the SL CLI measurements.

Certain aspects provide a second user equipment (UE). The second UE generally includes means for receiving a sidelink (SL) cross-link interference (CLI) configuration from a second base station indicating resources for performing the SL CLI measurements, means for performing the SL CLI measurements on the resources indicated in the SL CLI configuration, and means for transmitting a report to the second base station indicating the SL CLI measurements.

Certain aspects provide a second user equipment (UE). The second UE generally includes a transceiver configured to receive a sidelink (SL) cross-link interference (CLI) configuration from a second base station indicating resources for performing the SL CLI measurements. The second UE may also include a processing system that includes at least one processor configured to perform the SL CLI measurements on the resources indicated in the SL CLI configuration. In some cases, the transceiver is further configured to transmit a report to the second base station indicating the SL CLI measurements.

Certain aspects provide an apparatus for wireless communications by a second user equipment (UE). The apparatus generally includes a first interface configured to receive a sidelink (SL) cross-link interference (CLI) configuration from a second base station indicating resources for performing the SL CLI measurements. The apparatus may also include a processing system that includes at least one processor configured to perform the SL CLI measurements on the resources indicated in the SL CLI configuration. In some cases, the apparatus may also include a second interface configured to output a report for transmission to the second base station indicating the SL CLI measurements.

Certain aspects provide a computer-readable medium for wireless communications. The computer-readable medium includes codes executable to receiving a sidelink (SL) cross-link interference (CLI) configuration from a second base station indicating resources for performing the SL CLI measurements, performing the SL CLI measurements on the resources indicated in the SL CLI configuration, and transmitting a report to the second base station indicating the SL CLI measurements.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

The following description and the appended figures set forth certain features for purposes of illustration.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A and FIG. 4B show diagrammatic representations of example vehicle to everything (V2X) systems, in accordance with certain aspects of the present disclosure.

FIG. 5A and FIG. 5B illustrate different interference scenarios between wireless communication devices belonging to different networks.

FIG. 6 illustrates configuration information for cross-link interference (CLI) measurements, in accordance with certain aspects of the present disclosure.

FIG. 7 is a call flow diagram illustrating example operations for facilitating sidelink CLI measurements, in accordance with certain aspects of the present disclosure.

FIG. 8 is a flow diagram illustrating example operations for wireless communication by a first UE, in accordance with certain aspects of the present disclosure.

FIG. 9 is a flow diagram illustrating example operations for wireless communication by a first BS, in accordance with certain aspects of the present disclosure.

FIG. 10 is a flow diagram illustrating example operations for wireless communication by a second BS, in accordance with certain aspects of the present disclosure.

FIG. 11 is a flow diagram illustrating example operations for wireless communication by a second UE, in accordance with certain aspects of the present disclosure.

FIG. 12 illustrates a communications device that may include various components configured to perform operations for the techniques disclosed herein in accordance with aspects of the present disclosure.

FIG. 13 illustrates a communications device that may include various components configured to perform operations for the techniques disclosed herein in accordance with aspects of the present disclosure.

FIG. 14 illustrates a communications device that may include various components configured to perform operations for the techniques disclosed herein in accordance with aspects of the present disclosure.

FIG. 15 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for facilitating sidelink (SL) cross-link interference (CLI) measurements in a wireless communication system. For example, in some cases, user equipments (UEs) and base stations (BSs) of different networks may cause interference to each other, known as cross-link interference. For example, in some cases, transmissions on communication links between a first BS and a first UE in a first UE may cause interference to communication links between a second BS and a second UE. In some cases, to help reduce or eliminate CLI, UEs may perform CLI measurements and report these measurements to their serving base station. The serving base station may then adjust one or more transmission parameters of their served UEs to reduce or eliminate the CLI. In some cases, such CLI measurement could be performed using sidelink communications. Performing CLI measurements on the SL may be more advantageous over traditional methods for measuring CLI as SL-based CLI measurements may not require the transmission of additional signaling to perform the CLI measurements. That is, the SL-based CLI measurements may be performed on normally-occurring SL-based signaling without the need of, for example, special CLI-based reference signals.

The following description provides examples of facilitating SL CLI measurements in wireless communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

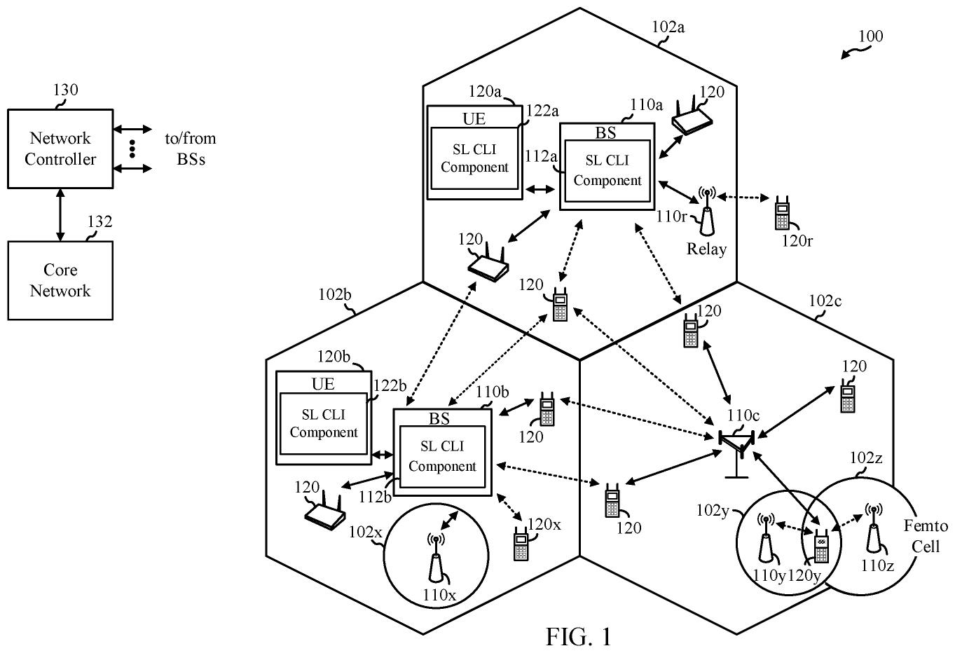

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

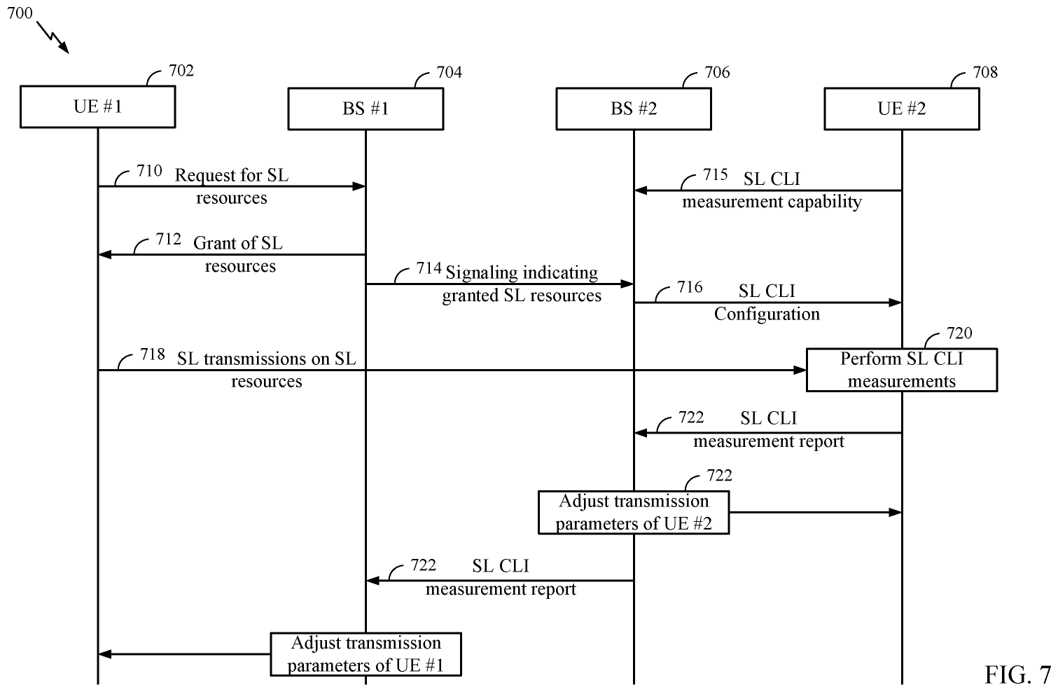

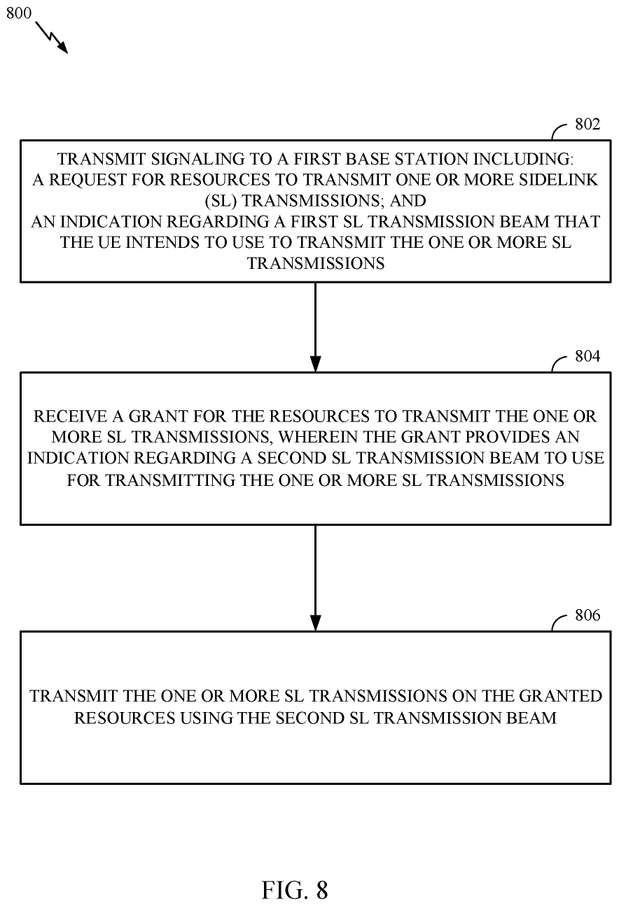

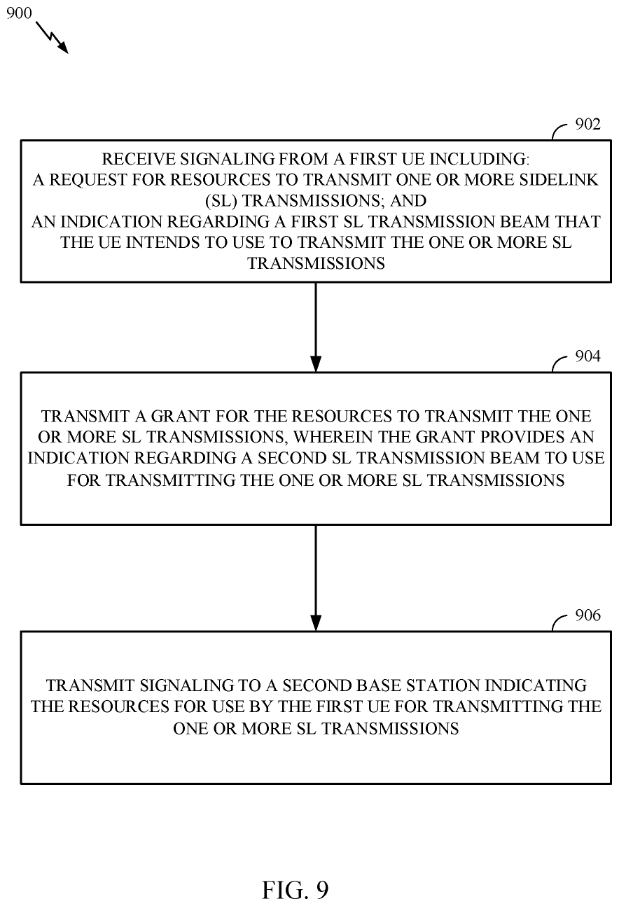

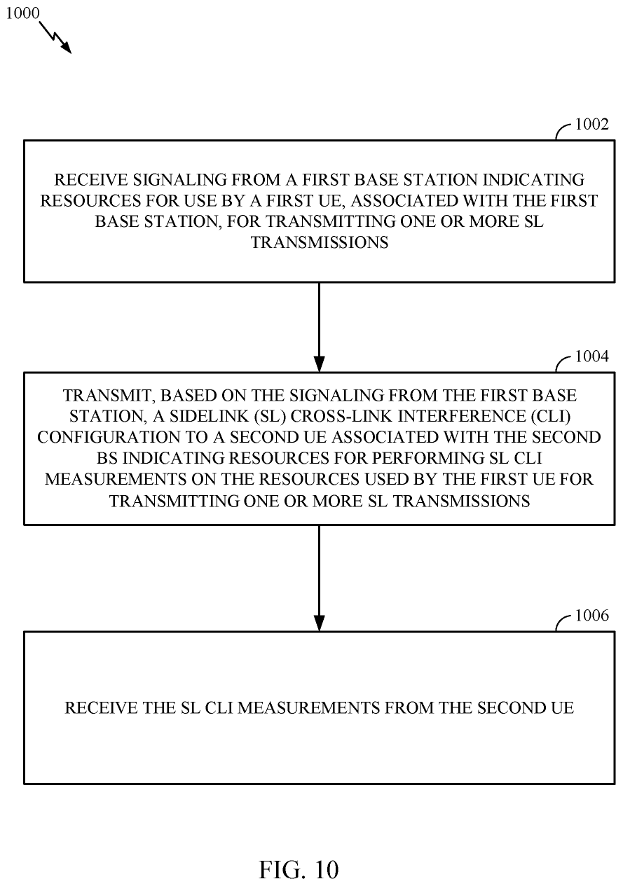

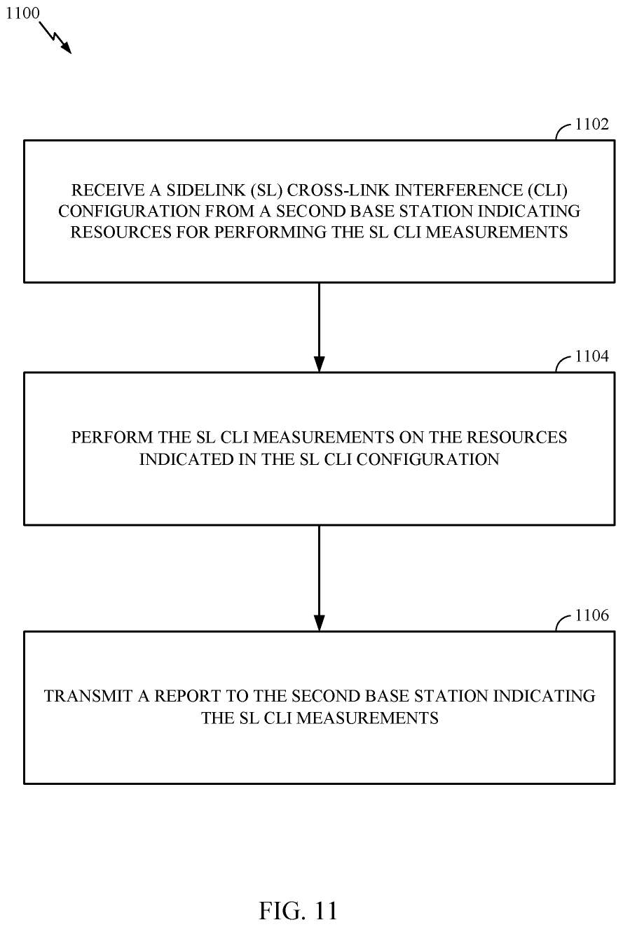

According to certain aspects, the BSs 110 and UEs 120 may be configured for facilitating SL CLI measurements in wireless communication systems, as described herein. For example, as shown in FIG. 1, the UE 120a may include a SL CLI component 122a that may be configured to perform the operations in, and described with respect to, FIG. 7 and/or FIG. 8, as well as other operations described herein for facilitating SL CLI measurements. Similarly, the UE 120b may also include a SL CLI component 122b that may be configured to perform the operations in, and described with respect to, FIG. 7 and/or FIG. 11, as well as other operations described herein for facilitating SL CLI measurements. Additionally, the BS 110a may include a SL CLI component 112a that may be configured to perform the operations in, and described with respect to, FIG. 7 and/or FIG. 9, as well as other operations described herein for facilitating SL CLI measurements. Similarly, the BS 110b may include a SL CLI component 112b that may be configured to perform the operations in, and described with respect to, FIG. 7 and/or FIG. 10, as well as other operations described herein for facilitating SL CLI measurements.

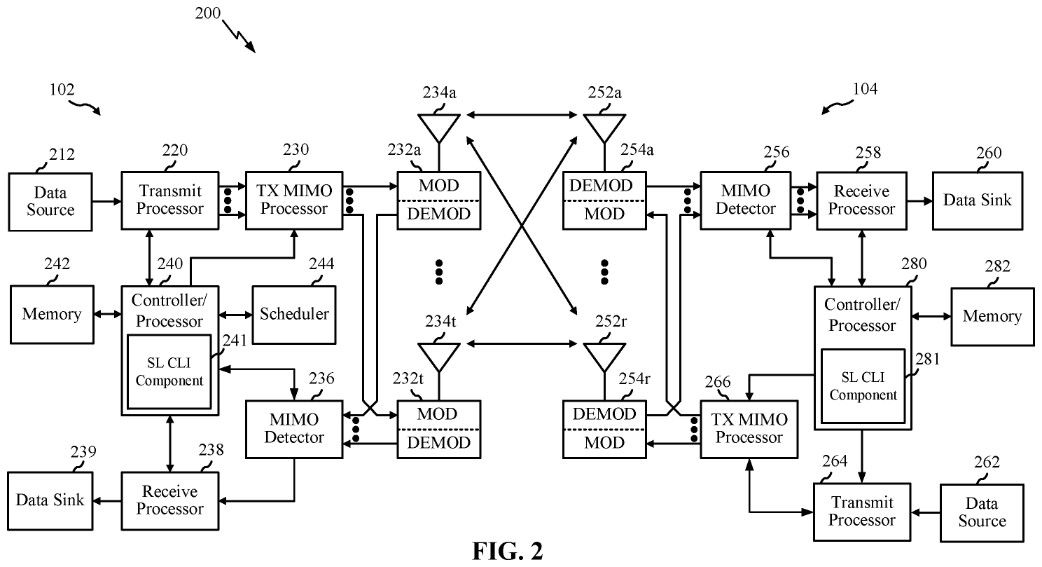

FIG. 2 illustrates example components of BSs 110a and UE 120a (e.g., the wireless communication network 100 of FIG. 1), which may be used to implement aspects of the present disclosure. While FIG. 2 is described with respect to the BS 110a and UE 120a, it should be understood that the components shown in FIG. 2 may also be included with other BSs and UEs illustrated in FIG. 1, such as BS 110b and UE 120b.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. As shown, the controller/processor 240 of the BS 110a may include a SL CLI component 241 that may be configured to perform the operations in, and described with respect to, FIG. 7 and/or FIG. 9, as well as other operations described herein for facilitating SL CLI measurements. Further, as shown in FIG. 2, the controller/processor 280 of the UE 120a may include a SL CLI component 281 that may be configured to perform the operations in, and described with respect to, FIG. 7 and/or FIG. 8, as well as other operations described herein for facilitating SL CLI measurements.

Additionally, as noted above, while FIG. 2 is described with respect to the BS 110a and UE 120a, it should be understood that the components shown in FIG. 2 may also be included with other BSs and UEs illustrated in FIG. 1, such as BS 110b and UE 120b. Accordingly, in some cases, the BS 110a shown in FIG. 2 may include the BS 110b and UE 120a may include the UE 120b. In such cases, the SL CLI component 241 shown in FIG. 2 may be configured to perform the operations in, and described with respect to, FIG. 7 and/or FIG. 10, as well as other operations described herein for facilitating SL CLI measurements. Similarly, in some cases, the SL CLI component 281 may be configured to perform the operations in, and described with respect to, FIG. 7 and/or FIG. 11, as well as other operations described herein for facilitating SL CLI measurements.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

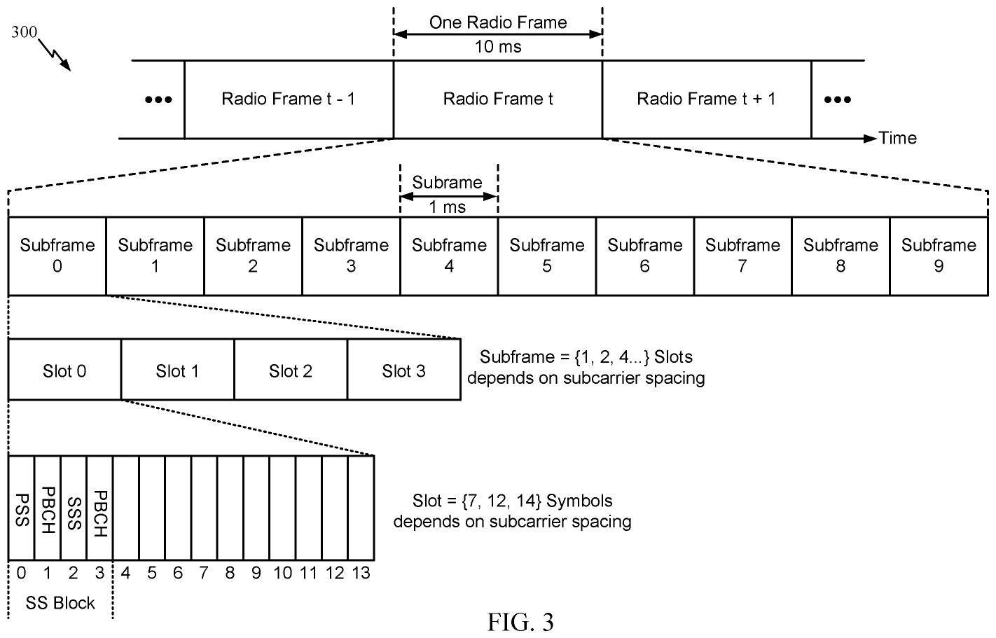

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

### Example Sidelink Communication

In some examples, two or more subordinate entities (e.g., UEs 120) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE 120a) to another subordinate entity (e.g., another UE 120) without relaying that communication through the scheduling entity (e.g., UE 120 or BS 110), even though the scheduling entity may be utilized for scheduling and/or control purposes. In some examples, the sidelink signals may be communicated using a licensed spectrum (unlike wireless local area networks, which typically use an unlicensed spectrum). One example of sidelink communication is PC5, for example, as used in V2V, LTE, and/or NR.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations, resource reservations, and other parameters used for data transmissions, and the PSSCH may carry the data transmissions. The PSFCH may carry feedback such as acknowledgement (ACK) and or negative ACK (NACK) information corresponding to transmissions on the PSSCH. In some systems (e.g., NR Release 16), a two stage SCI may be supported. Two stage SCI may include a first stage SCI (SCI-1) and a second stage SCI (e.g., SCI-2). SCI-1 may include resource reservation and allocation information, information that can be used to decode SCI-2, etc. SCI-2 may include information that can be used to decode data and to determine whether the UE is an intended recipient of the transmission. SCI-1 and/or SCI-2 may be transmitted over PSCCH.

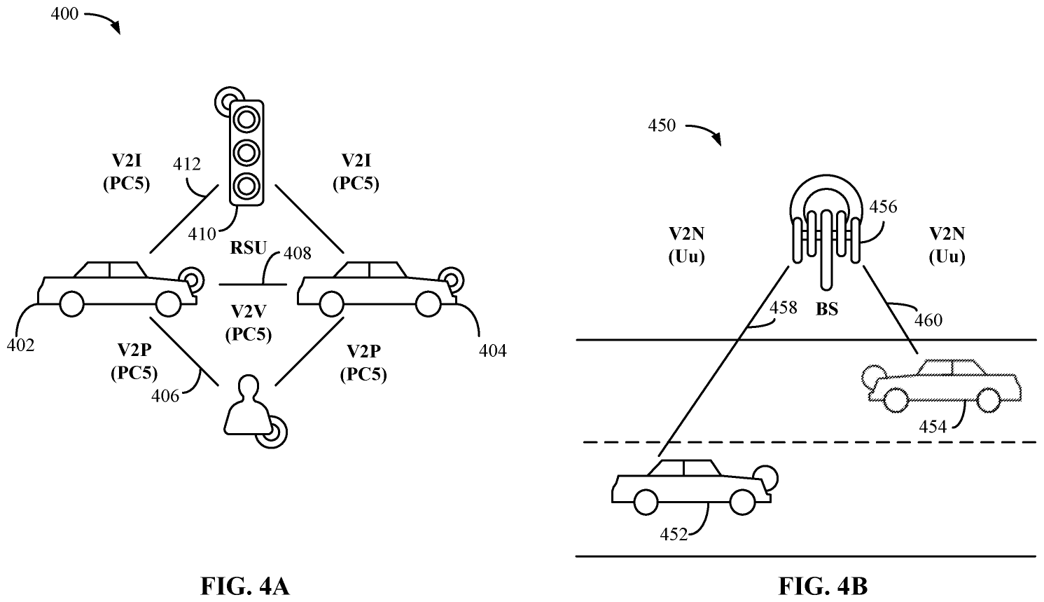

FIG. 4A and FIG. 4B show diagrammatic representations of example V2X systems, in accordance with some aspects of the present disclosure. For example, the vehicles shown in FIG. 4A and FIG. 4B may communicate via sidelink channels and may relay sidelink transmissions as described herein.

The V2X systems provided in FIG. 4A and FIG. 4B provide two complementary transmission modes. A first transmission mode (also referred to as mode 4), shown by way of example in FIG. 4A, involves direct communications (for example, also referred to as sidelink communications) between participants in proximity to one another in a local area. A second transmission mode (also referred to as mode 3), shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle-to-vehicle (V2V) communications) is illustrated with two vehicles 402, 404. In some cases, the two vehicles 402, 404 may be referred to as UEs. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V21) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 (e.g., also referred to as UEs) through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 460 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V21 communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

### Example Cross-Link Interference Between Networks

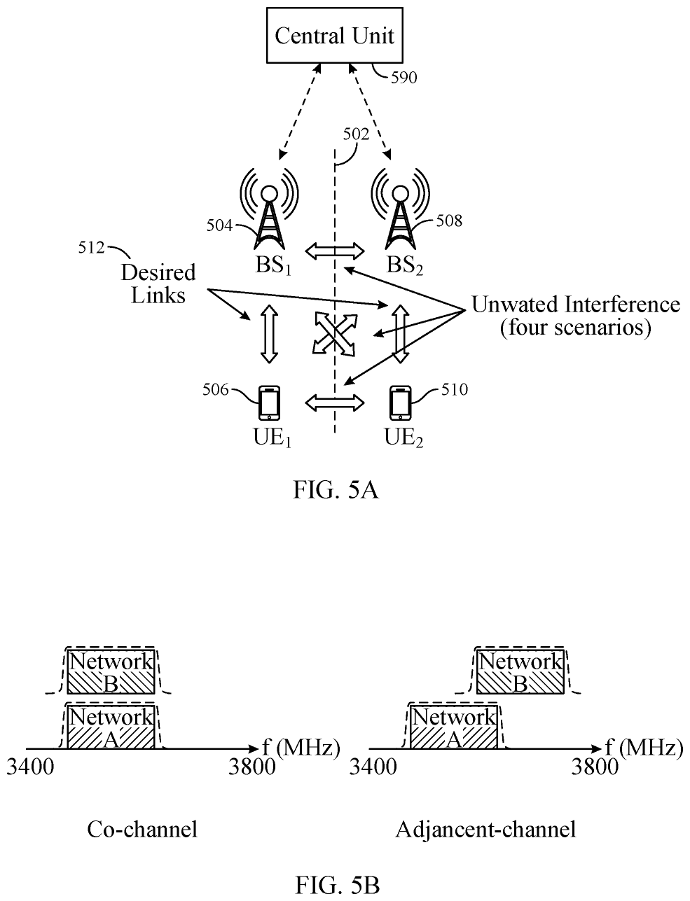

In some cases, 5G communication systems may implement time-division duplex (TDD)-type communications, whereby transmissions in uplink (UL) and downlink (DL) share an entire frequency spectrum, but in different time slots. TDD-type networks may be implemented in a frequency band, such as 3400-3800 MHz. These TDD networks may cause cross-link interference (CLI) between different networks of different operators, as described in more detail with respect to FIGS. 5A and 5B. For example, cross-link interference CLI may occur when simultaneous transmissions in UL and DL directions take place in different TDD networks.

FIGS. 5A and 5B illustrates two network associated with different operators implemented across a border 502. A first base station (BS) 504 and a first UE 506 (e.g., mobile station) may be associated with a first network (e.g., network A) of a first operator and a second BS 508 a second UE 510 may be associated with a second network (e.g., network B) of a second operator. The first and second BSs 504, 508 and the first and second UEs 506, 510 may cause interference to one or more desired links 512 of each network. CLI may occur BS to BS, UE to UE, and/or the like. For example, during a downlink transmission the first UE 506 may experience CLI by caused by an uplink transmission by the second UE 510. As another example, a downlink transmission by the first BS 504 may cause CLI with an uplink transmission that is received by the second BS 508.

Different interference scenarios may occur when two TDD networks are deployed in blocks within the same band or adjacent bands (including co-channel interference and adjacent channel interference, as illustrated in FIG. 5B). For example, there may be four cross-link interference scenarios including interference between the base stations 504, 508, interference between the UEs 506, 510, interference between base station 504 and UE 510, or interference between base station 508 and UE 506. In some aspects, the base stations 504, 508 may be in communication with a central unit 590, as illustrated, which may include, for example, the network controller 130 illustrated in FIG. 1.

As illustrated in FIG. 5B, the interference between the links (e.g., cross-link interference) may be co-channel interference or adjacent channel interference. Co-channel interference occurs when two links of different networks (e.g., network A and network B) are configured on the same band, and adjacent channel interference occurs when the links are configured on adjacent bands, yet still interfere due to adjacent channel leakage ratio (ACLR) of the links.

In some cases, cross-link interference may be reduced if different networks perform synchronous operation. For example, for synchronous operation, two different links of the different networks may be synchronized such that both different networks are performing only DL or only UL at any point in time. In other words, simultaneous UL and DL transmissions do not take place in case of synchronized operation, but do take place in case of unsynchronized operation, as described in more detail herein.

In other words, for synchronous operation, simultaneous UL/DL transmissions do not occur. That is, at any given moment in time, either all networks transmit in DL or all networks transmit in UL. This helps avoid interference between the transmission of one base station and the reception of another base station in the same or an adjacent network since both base station are either transmitting or receiving. To implement synchronous operation, a common frame structure with time and phase synchronization may be configured between networks. On the other hand, asynchronous or unsynchronized operation may not implement the adoption of a compatible frame structure between networks. Therefore, each network may be perform uplink or downlink communication at will without considering other networks, which may result in interference on links in each network, such as the desired links 512 illustrated in FIG. 5A.

### Example Sidelink Cross-Link Interference Measurements

As noted above, cross link interference (CLI) may refer to interference experiences by a wireless communication link between a first base station (BS) and a first user equipment (UE) that is caused by transmissions on a wireless communication link between a second BS and a second UE. In some aspects, measurement of CLI and reporting may be used to mitigate the CLI. For instance, an aggressor UE (e.g., a UE that is causing CLI) may transmit a CLI reference signal (CLI-RS) to a victim UE (e.g., a UE that is being interfered with by the CLI). The victim UE may measure the CLI-RS and provide a feedback or measurement report so that one or more transmission parameters of the aggressor UE may be adjusted (e.g., transmit power, frame structure, and/or the like) to reduce and/or eliminate the CLI.

As noted above, a CLI reference signal (RS) may be transmitted by a UE and received or measured by another UE. In some cases, the CLI RS may comprise a CLI sounding reference signal (SRS). In other cases, CLI may be measured based on other types of signals, such as signals transmitted on a control channel (e.g., physical uplink control channel (PUSCH)) and/or data channel (e.g., physical uplink shared channel (PUSCH)) In some cases, measured CLI metrics may include reference signal received power (RSRP), reference signal received quality (RSRQ), and/or received signal strength indicator (RSSI). RSRP is a measurement of a reference signal that can be received and decoded by the receiving UE. RSSI is a measure of the total received power in the bandwidth that is measured. RSSI may include signals from any source (e.g., PDUCH and/or PUDSCH) and not just from the transmitted reference signal.

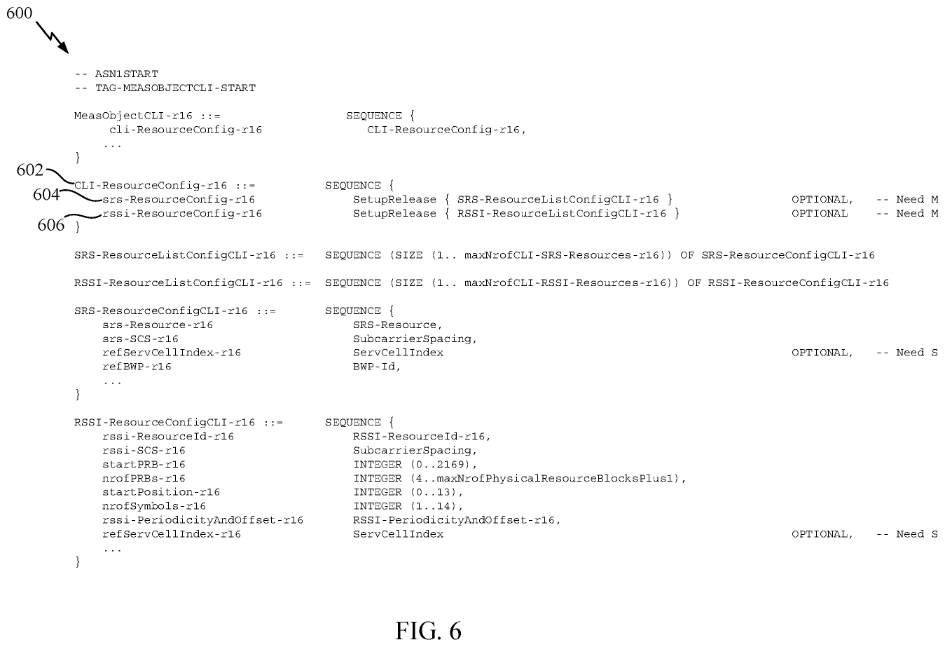

In some cases, a serving BS may configure a UE with resources for performing CLI measurements, as illustrated in FIG. 6. For example, as illustrated, the BS may configure the UE with a CLI resource configuration 602. The CLI resource configuration 602 may include an SRS resource configuration 604 as well as an RSSI resource configuration 606. The SRS resources configuration 604 may include SRS resources (e.g., time and frequency resources) to be used for CLI measurements. Similarly, the RSSI resource configuration may include CLI-RSSI resources to be used for CLI measurements. The UE may then perform CLI measurements on the configured resources based on UL transmissions (e.g., SRS or PUCCH/PUSCH) from another UE, such as UE in a different network served by another BS. The UE may then report the CLI measurements to the serving BS. In some cases, if CLI (e.g., based on the CLI measurements) is above a threshold, transmission parameters of the other UE may be adjusted (e.g., transmit power, frame structure, and/or the like) to reduce and/or eliminate the CLI.

While these CLI measurements may allow transmission parameters of an aggressor UE to be adjusted to reduce or eliminate CLI, such CLI measurements require separate resources over a Uu interface for transmitting signals specifically for the CLI measurements. In some cases, sidelink (SL) may also be used for CLI measurements over a PC5 interface (e.g., in contrast to the UE/BS interface, Uu). One benefit of using SL for CLI measurements is that, if the other UEs are participating in SL, then no additional UL transmissions (e.g., SRS or PUCCH/PUSCH) are needed to gather CLI measurements. Further, unlike Uu interface-based CLI measurements, which may be periodic, non-periodic CLI measurements may be performed using SL, providing more scheduling flexibility.

Therefore, aspects of the present disclosure provide techniques for facilitating SL-based CLI measurements. In some cases, the techniques presented herein may provide various enhancements, such as buffer status report (BSR) or other signaling enhancements for SL and UL beam correspondence. For example, traditionally, a BS may not be aware of a SL transmission (Tx) beam that a UE is using for SL transmissions or this SL Tx beam's correspondence to UL Tx beams. As CLI measurements are needed corresponding to an UL Tx beam used by the other UE and not the SL Tx beam, information regarding the SL Tx beam's correspondence with the UL Tx beam may be advantageous when performing CLI measurements on an SL Tx beam for CLI caused by a UL Tx beam. Additional enhancements may include SL grant enhancements, CLI information element (IE) enhancements, enhancements allowing certain UE's to perform SL CLI measurements that are not capable of full SL communication, and enhancements to layer 1 (L1) and layer (3) reporting.

FIG. 7 is a call flow diagram illustrating example operations 700 for facilitating sidelink CLI measurements, in accordance with certain aspects of the present disclosure. As illustrated, the operations 700 include operations performed by a first UE 702 (e.g., UE 120a, 402, 452, 506) that is associated with a first BS (e.g., BS 110a, 456, 504) and a second UE 708 (e.g., UE 120b, 404, 454, 508) that is associated with a second BS (e.g., BS 110b, 456, 508). In some cases, the second UE 708 may comprise a UE that is capable of SL CLI measurements but not capable of full SL communication. In other cases, the second UE 708 may be fully capable of SL communication (e.g., with the first UE 702 or any other SL-capable UE).

Operations 700 begin at 710 with the first UE 702 transmitting signaling including a request for resources to transmit one or more sidelink (SL) transmissions, which may be received by the first BS 704. In some cases, the request may comprise a buffer status report (BSR) that requests control and/or data resources for the one or more SL transmissions. In other cases, the one or more transmissions may include at least one of SL control or data transmissions. In some cases, the one or more SL transmissions may comprise SL channel state information reference signal (CSI-RS), which may be used by the UE to perform SL beam management.

In some cases, as the first BS 704 may not be aware of which beams a UE uses for the one or more SL transmissions, the signaling may further include an indication regarding a first SL transmission (Tx) beam that the UE intends to use to transmit the one or more SL transmissions. The indication regarding the first SL Tx beam may include, for example, a self-assigned SL Tx beam index of the first SL Tx beam or a particular SL transmission configuration indicator (TCI) state associated with the first SL Tx beam. In some cases, indication regarding the first SL Tx beam may, additionally or alternatively, include an indication of a spatial quasi-colocation (QCL) relationship between the SL Tx beam that the UE intends to use for the one or more SL transmissions and one or more uplink (UL) Tx beams used for uplink transmissions to the first BS 704, for example, when the SL Tx beam is indeed quasi-colocated (QLC'd) with the one or more UL Tx beams. In some cases, the UL Tx beam may be associated with or identified by a sounding reference signal index (SRI).

According to aspects, indicating a spatial QCL relationship between the SL Tx beam and one or more UL Tx beams used by the first UE 702, may allow the first BS 704 to determine whether SL transmissions from the first UE 702 may be used for performing CLI measurements. For example, the purpose of CLI measurements is to determine the UE to UE interference caused when a UE (e.g., the first UE 702) is transmitting on UL to its serving base station (e.g., the first BS 704) and another UE (e.g., the second UE 708) is receiving on DL from its serving base station (e.g., the second BS 706). If the SL Tx beam does not have a spatial QCL relationship with the one or more UL Tx beams, then the interference that transmissions of the first UE 702 create at the second UE 708 will be different on SL versus UL. In such cases, the SL Tx beam may not be used for the CLI measurements. If, however, SL Tx beam has a spatial QCL relationship with the one or more UL beams, then transmissions from that UE on the SL Tx beam may be used for performing CLI measurements due to the QCL relationship of the SL and UL beams.

In some cases, the information regarding the first SL Tx beam may be transmitted in different types of signaling and may be transmitted together with, or separate from, the request for the SL resources. For example, in some cases, the indication regarding the first SL Tx beam may be transmitted in a media access control control element (MAC CE) used for carrying a BSR (e.g., the request for SL resources) or may comprise a MAC CE that is separate from the MAC CE used for carrying the BSR. In other cases, the indication regarding the first SL Tx beam may be transmitted in radio resource control (RRC) signaling as a semi-static configuration.

Thereafter, at 712, the first BS 704 may transmit a grant for the resources to transmit the one or more SL transmissions, which may be received by the first UE 702. In some cases, the grant may include time and frequency resources for performing the one or more SL transmissions. Additionally, in some cases, the grant may be a semi-persistently scheduled (SPS) grant, granting resources on a semi-persistent basis.

The first UE 702 may then, based on the grant, determine a SL Tx spatial configuration (e.g., a SL Tx beam) to use when transmitting the one or more SL transmissions using the granted resources. For example, in some cases, the grant may provide an indication regarding a second SL Tx beam (e.g., an SL Tx spatial configuration) to use for transmitting the one or more SL transmissions. In some cases, the second SL Tx beam to use for transmitting the one or more SL transmissions (e.g., indicated by the transmitted grant) may include the first SL Tx beam that the first UE 702 intends to use for the one or more SL transmissions and that was indicated in the signaling transmitted to the first BS 704 in 710. In some cases, when the second SL Tx beam includes the first SL Tx beam, the indication regarding the second SL Tx beam may be provided via the SL Tx beam index of the first SL Tx beam or via the SL TCI state associated with the SL Tx beam.

In other cases, the second SL Tx beam may include a SL Tx beam different from the first SL TX beam indicated by the first UE 702. For example, in some cases, the first BS 704 may select an UL Tx beam that has the QCL relationship with the first SL Tx beam indicated by the first UE 702 in the signaling at 710. Accordingly, in some cases, the indication regarding the second SL Tx beam may include the UL Tx beam that has the QCL relationship with the first SL Tx beam. In such cases, the indication regarding the second SL Tx beam may include an SRI of the UL Tx beam.

In some cases, when the grant does not include an explicit indication of the second SL Tx beam, the second SL transmission beam comprises the first SL transmission beam indicated by the first UE. For example, in such cases, the first UE 702 may infer based on the grant not including the explicit indication of the second SL Tx beam that the first BS 704 did not change the first SL Tx beam indicated by the first UE 702 in the signaling at 710. Therefore, the first UE 702 may assume that the second SL Tx beam is the same as the first SL Tx beam.

In some cases, as illustrated at 714, in addition to transmitting the grant for the resources at 712 to the first UE 702, at 714, the first BS 704 may also transmit signaling to the second BS 706 indicating the resources for use by the first UE 702 for transmitting the one or more SL transmissions. In other words, at 714, the second BS 706 may receive signaling from the first BS 704 indicating the granted resources for use by the first UE 702 for transmitting the one or more SL transmissions.

Thereafter, at 716, the second BS 706 may transmit, based on the signaling from the first BS 704 received at 714, a SL CLI configuration to the second UE 708 indicating resources for performing SL CLI measurements on the resources used by the first UE for transmitting one or more SL transmissions. Additionally, in some cases, the second BS 706 may also transmit, to the second UE 708, a DL TCI state to perform the SL-CLI measurements.

For example, in some cases, the second BS 706 may determine, based on the signaling received at 714, the resources that will be used by the first UE 702 for transmitting the one or more SL transmissions. The second BS 706 may then generate the SL CLI configuration that indicates resources for performing the SL CLI measurements, for example, which may be the resources that will be used by the first UE 702 for transmitting the one or more SL transmissions.

In some cases, the resources for performing the SL CLI measurements may include time and frequency resources for a sidelink control channel (e.g., physical sidelink control channel (PSCCH)) and a sidelink data channel (e.g., physical sidelink shared channel (PSSCH)). In some cases, the resources for performing the SL CLI measurements may include time and frequency resources for only a sidelink data channel. In some cases, the resources for performing the SL CLI measurements may include resources for receiving one or more CSI-RSs. In some cases, the SL CLI configuration may comprise a semi-persistent grant that includes resources for performing the SL CLI measurements that are semi-persistently scheduled.

In some cases, the SL CLI configuration may be based on a capability of the second UE 708 for performing the SL CLI measurements. For example, as illustrated at 715, at some point before the SL CLI configuration is transmitted to the second UE 708, the second UE 708 may transmit signaling to the second BS 706 indicating a capability of the second UE for performing the SL CLI measurements. In some cases, the capability of the second UE for performing the SL CLI measurements indicates a capability for performing RSRP measurements on DMRSs transmitted on at least one of a SL control channel or a SL data channel. In some cases, the capability of the second UE for performing the SL CLI measurements indicates a capability for performing RSRP measurements on SL CSI-RSs. The second BS 706 may take the capability information into account when generating the SL CLI configuration and may grant resources for measuring SL CLI according to the type of SL CLI measurements that the second UE 708 is capable of performing.

As noted, the second BS 706 may then transmit the SL CLI configuration to the second UE 708. Accordingly, the second UE 708 may receive the SL CLI configuration from the second base station at 716 indicating resources for performing the SL CLI measurements (e.g., the resources that will be used by the first UE 702 for transmitting the one or more SL transmissions).

Thereafter, at 718, the first UE 702 may transmit the one or more SL transmissions on the resources granted at 712 using the second SL Tx beam. As noted above, in some cases, one or more SL transmissions may include SL CSI-RSs. Additionally, in some cases, the one or more SL transmissions may comprise SL demodulation reference signals (DMRSs).

As illustrated at 720, the second UE 708 may perform the SL CLI measurements on the resources indicated in the SL CLI configuration received at 716. In some cases, the second UE 708 may perform the SL CLI measurements based on the DL TCI state indicated by the second BS 706, for example, by using a receive beam associated with the indicated downlink TCI state. In some cases, the second UE 708 may perform the SL CLI measurements by measuring RSRP of one or more SL CSI-RSs transmitted by the first UE 702.

In some cases, the second UE 708 may perform the SL CLI measurements by measuring a reference signal received power (RSRP) of one or more DMRSs transmitted on a sidelink control channel (e.g., PSCCH) by the first UE 702 associated with the first BS 704.

In some cases, the second UE 708 may perform the SL CLI measurements by measuring a received signal strength indicator (RSSI) on time and frequency resources for at least one of a control channel or a data channel via which a first UE 702, associated with the first BS 704, transmits. In this case, the control channel may comprise a sidelink control channel (e.g., PSCCH) or an uplink control channel (e.g., PUCCH) on which the first UE 702 transmits. Similarly, the data channel may comprise a sidelink control channel (e.g., PSSCH) or an uplink data channel (e.g., PUSCH) on which the first UE 702 transmits.

In some cases, the second UE 708 may perform the SL CLI measurements by measuring RSRP of DMRSs transmitted on sidelink control channels and sidelink data channels, for example, if the second UE 708 is capable of full SL communication (e.g., the second UE 708 is capable of decoding control and data on the SL). For example, in some cases, the second UE 708 may perform the SL CLI measurements by measuring a first RSRP of one or more DMRSs transmitted on a sidelink control channel (e.g., PSCCH) by the first UE 702 and measuring a second RSRP of one or more DMRSs transmitted on a sidelink data channel (e.g., PSSCH) by the first UE 702.

In some cases, the second UE 708 may perform the SL CLI measurements based on timing information received from the second BS 706. For example, the second UE 708 receiving timing information for performing the SL CLI measurements. In some cases, the timing information may be received from the second BS 706 in the SL CLI configuration. In other cases, the timing information may be received from the second BS 706 in signaling separate from the SL CLI configuration.

There may be different types of timing information that the second UE 708 could use to perform the SL CLI measurements. For example, in some cases, the timing information may include a downlink timing advance that is approximately equal to an uplink timing advance used by a first UE 702 for transmissions (e.g., the one or more SL transmissions transmitted at 718) on the resources used for performing the SL CLI measurements. In some cases, the timing information may include an SL timing reference based on a global navigation satellite system (GNSS) time. In some cases, the timing information may include a SL timing reference received from a first UE 702 that has a SL connection with the second UE 708. In such cases, the SL CLI configuration received from the second BS 706 may include a source identifier (ID) associated with the first UE 702 that the second UE 708 may use to determine the SL timing reference.

In some cases, when performing the SL CLI measurements, the second UE 708 may need to take into consideration whether the SL CLI measurements conflict with other non-SL scheduled CLI measurements. For example, as discussed above with respect to FIG. 6, in some cases, the second UE 708 may receive a CLI RSSI configuration indicating resources for performing (non-SL) CLI RSSI measurements associated with the second BS 706. Additionally or alternatively, the second UE 708 may receive a CLI SRS configuration indicating resources for performing CLI measurements on one or more SRSs associated with the second BS 706.

In some cases, at least one of the CLI RSSI configuration or the CLI SRS configuration may overlap (e.g., conflict with) the SL CLI configuration received from the second BS 706 at 716. In such cases, performing the SL CLI measurements may be based on the overlap. For example, in some cases, performing the SL CLI measurements may include prioritizing, based on the overlap, measurements associated with the CLI RSSI configuration or measurements associated with the CLI SRS configuration over measurements associated with the SL CLI configuration. In other words, if there is an overlap between the CLI RSSI configuration/CLI SRS configuration and the SL CLI configuration (e.g., resources for these configurations overlap, such that the second UE 708 is supposed to do two different types of CLI measurements at the same time), the second UE may decide to prioritize either the CLI RSSI measurements or CLI SRS measurements over the SL CLI measurements. In other cases, the second UE 708 may decide to prioritize the SL CLI measurements over the CLI RSSI measurements and/or CLI SRS measurements. In some cases, prioritizing the SL CLI measurements may include releasing, based on the received SL CLI configuration, at least one of the resources associated with the CLI RSSI configuration or the resources associated with the CLI SRS configuration. By releasing these resources, these resources may be used by the second BS 706 or second UE 708 for other purposes (e.g., transmitting control and/or data).

Thereafter, as illustrated at 722, the second UE 708 may transmit a report to the second base station indicating the SL CLI measurements. Accordingly, based on the report indicating the SL CLI measurements, the second BS 706 may adjust one or more transmission parameters of the second UE 708 in an effort to reduce or eliminate the measured CLI. In some cases, the second BS 706 may adjust the one or more transmission parameters if the measured CLI is greater than or equal to a threshold. For example, in some cases, the one or more transmission parameters of the second UE 708 that may be adjusted by the second BS 706 may include a time division duplexing (TDD) configuration associated with the second UE 708 or one or more downlink TCI states of the second UE 708. In some cases, the one or more transmission parameters of the second UE 708 that may be adjusted by the second BS 706 may include a transmit power, a frame structure, a Tx beam, and the like, associated with the second UE 708. The second BS 706 may then send the adjusted transmission parameters to the second UE 708. The second UE 708 may then use the adjusted transmission parameters when performing transmissions so as to reduce or eliminate the measured CLI.

Further, as shown at 722, the second BS 706 may also transmit signaling to the first base station indicating the SL CLI measurements. That is, as shown at 722, the first BS 704 may receive signaling from the second BS 706 indicating the SL CLI measurements performed by the second UE 708. Based on the SL CLI measurements, the first BS 704 may adjust one or more transmission parameters of the first UE 702 in an effort to reduce or eliminate CLI caused by the second UE 708. In some cases, the one or more transmission parameters of the first UE 702 that may be adjusted by the first BS 704 may include a TDD configuration associated with the first UE 702 or one or more uplink transmission beams of the first UE 702. In some cases, the first BS 704 may adjust the one or more transmission parameters of the first UE 702 if the measured CLI is greater than or equal to a threshold.

Returning now to 718 and 720 of FIG. 7, there may be instances in which the first UE 702 may fail to perform the one or more SL transmissions on the granted resources (e.g., the resources used by the second UE 708 to perform the SL CLI measurements). Such cases may lead to the second UE 708 reporting erroneous SL CLI measurements to the second BS 706. For example, in some cases, if the first UE 702 fails to transmit the one or more SL transmissions on the resources used by the second UE 708 to perform the SL CLI measurements, the second UE 708 may believe that there is no CLI being caused when there really is. In this case, the second UE 708 may report to the second BS 706 that there is no CLI (or this is some amount of CLI below a threshold), preventing the second BS 706 from taking action to reduce or eliminate the CLI that actually exists (e.g., by adjusting transmission parameters). Different techniques may be used to help alleviate this issue.

For example, in some cases, the first UE 702 may fail to perform the one or more SL transmissions due to a conflict with SL reception or due to having to perform other transmissions of higher priority that are scheduled at the same time or on the same resources as the one or more SL transmissions. In such cases, to help avoid situations where the second UE 708 transmits an erroneous SL CLI measurement report due to the first UE 702 not transmitting the one or more SL transmissions, the first UE 702 may receive additional signaling from the first BS 704 that configures the first UE 702 to either prioritize the one or more SL transmissions over the other transmissions or transmit an indication to the first BS when the first UE is not able to perform the one or more SL transmissions based on the requested resources. In other words, based on the additional signaling from the first BS 704, the first UE 702 may prioritize the one or more SL transmissions over the other transmissions or transmit an indication to the first BS 704 when the first UE 702 is not able to perform the one or more SL transmissions based on the requested resources.

In some cases, the second UE 708 may take action to help avoid situations involving the transmission of an erroneous SL CLI report. For example, in some cases, when performing the SL CLI measurements at 720 on the resources indicated in the SL CLI configuration, the second UE 708 may perform the SL CLI measurements on the resources regardless of whether a first UE 702 is performing one or more SL transmissions on the resources for performing the SL CLI measurements.

In other cases, the second UE 708 may actively sense whether the one or more SL transmissions are present on the resources used for the SL CLI measurements and may decide whether to transmit the SL CLI measurement report at 722 based on whether the one or more SL transmissions are sensed. For example, in some cases, performing the SL CLI measurements on the resources indicated in the SL CLI configuration may include detecting a presence or an absence of one or more SL transmissions on the resources. The second UE 708 may then transmit the SL CLI measurement report at 722 to the second BS 706 indicating the SL CLI measurements (only) when the presence of the one or more SL transmissions on the resources is detected.

In some cases, the second UE 708 may detect the absence of the one or more SL transmissions on the resources. In such cases, instead of transmitting the SL CLI measurement report (e.g., with erroneous measurements) the second UE 708 may transmit an indication of the absence of the one or more SL transmissions on the resources.

In other cases, the second UE 708 may detect the presence of the one or more SL transmissions on the resources and, accordingly, transmit the SL CLI measurements to the second BS 706. The second UE 708 may detect the presence of the one or more SL transmissions based successful decoding of the one or more SL transmissions on the resources. In other words, if the second UE 708 is able to successfully decode the one or more SL transmissions, the second UE 708 may infer that the one or more SL transmissions were present on the resources. In other cases, the second UE 708 may detect the presence of the one or more SL transmissions based on an RSRP or RSSI associated with the resources being greater than or equal to a threshold. For example, in some cases, if the second UE 708 is not capable of full SL communication (e.g., decoding SL transmissions), the UE may instead see whether an RSRP or RSSI associated with the resources greater than or equal to a threshold. If so, the second UE 708 may infer that the one or more SL transmissions were present on the resources.

FIG. 8 is a flow diagram illustrating example operations 800 for wireless communication, for example, for facilitating SL CLI measurements, in accordance with certain aspects of the present disclosure. The operations 800 may be performed, for example, by a first UE (e.g., the UE 120a, 402, 452, 506, 702). The operations 800 may be implemented as software components that are executed and run on one or more processors (e.g., controller/processor 280 of FIG. 2). Further, the transmission and reception of signals by the UE in operations 800 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 800 may begin, in block 802, by transmitting signaling to a first base station including: a request for resources to transmit one or more sidelink (SL) transmissions and an indication regarding a first SL transmission beam that the UE intends to use to transmit the one or more SL transmissions.

Operations 800 may continue, in block 804, by receiving a grant for the resources to transmit the one or more SL transmissions, wherein the grant provides an indication regarding a second SL transmission beam to use for transmitting the one or more SL transmissions.

Operations 800 may continue, in block 806, by transmitting the one or more SL transmissions on the granted resources using the second SL transmission beam.

FIG. 9 is a flow diagram illustrating example operations 900 for wireless communication, for example, for facilitating SL CLI measurements, in accordance with certain aspects of the present disclosure. The operations 800 may be performed, for example, by a first BS (e.g., BS 110a, 456, 504, 704). The operations 900 may be implemented as software components that are executed and run on one or more processors (e.g., controller/processor 240 of FIG. 2). Further, the transmission and reception of signals by the first BS in operations 900 may be enabled, for example, by one or more antennas (e.g., antennas 234 of FIG. 2). In certain aspects, the transmission and/or reception of signals by the first BS may be implemented via a bus interface of one or more processors (e.g., controller/processor 240) obtaining and/or outputting signals.

The operations 900 may begin, in block 902, by receiving signaling from a first UE including: a request for resources to transmit one or more sidelink (SL) transmissions and an indication regarding a first SL transmission beam that the UE intends to use to transmit the one or more SL transmissions.

Operations 900 may continue, in block 904, by transmitting a grant for the resources to transmit the one or more SL transmissions, wherein the grant provides an indication regarding a second SL transmission beam to use for transmitting the one or more SL transmissions.

Operations 900 may continue, in block 906, by transmitting signaling to a second base station indicating the resources for use by the first UE for transmitting the one or more SL transmissions.

FIG. 10 is a flow diagram illustrating example operations 1000 for wireless communication, for example, for facilitating SL CLI measurements, in accordance with certain aspects of the present disclosure. The operations 1000 may be performed, for example, by a second BS (e.g., BS 110b, 456, 508, 706). The operations 1000 may be implemented as software components that are executed and run on one or more processors (e.g., controller/processor 240 of FIG. 2). Further, the transmission and reception of signals by the second BS in operations 1000 may be enabled, for example, by one or more antennas (e.g., antennas 234 of FIG. 2). In certain aspects, the transmission and/or reception of signals by the second BS may be implemented via a bus interface of one or more processors (e.g., controller/processor 240) obtaining and/or outputting signals.

The operations 1000 may begin, in block 1002, by receiving signaling from a first base station indicating resources for use by a first UE, associated with the first base station, for transmitting one or more SL transmissions.

Operations 1000 may continue, in block 1004, by transmitting, based on the signaling from the first base station, a sidelink (SL) cross-link interference (CLI) configuration to a second UE associated with the second BS indicating resources for performing SL CLI measurements on the resources used by the first UE for transmitting one or more SL transmissions.

Operations 1000 may continue, in block 1006, by receiving the SL CLI measurements from the second UE.

FIG. 11 is a flow diagram illustrating example operations 1100 for wireless communication, for example, for facilitating SL CLI measurements, in accordance with certain aspects of the present disclosure. The operations 1100 may be performed, for example, by a second UE (e.g., the UE 120b, 404, 454, 508, 708). The operations 1100 may be implemented as software components that are executed and run on one or more processors (e.g., controller/processor 280 of FIG. 2). Further, the transmission and reception of signals by the UE in operations 1100 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1100 may begin, in block 1102, by receiving a sidelink (SL) cross-link interference (CLI) configuration from a second base station indicating resources for performing the SL CLI measurements.

Operations 1100 may continue, in block 1104, by performing the SL CLI measurements on the resources indicated in the SL CLI configuration.

Operations 1100 may continue, in block 1106, by transmitting a report to the second base station indicating the SL CLI measurements.

### Example Wireless Communication Devices

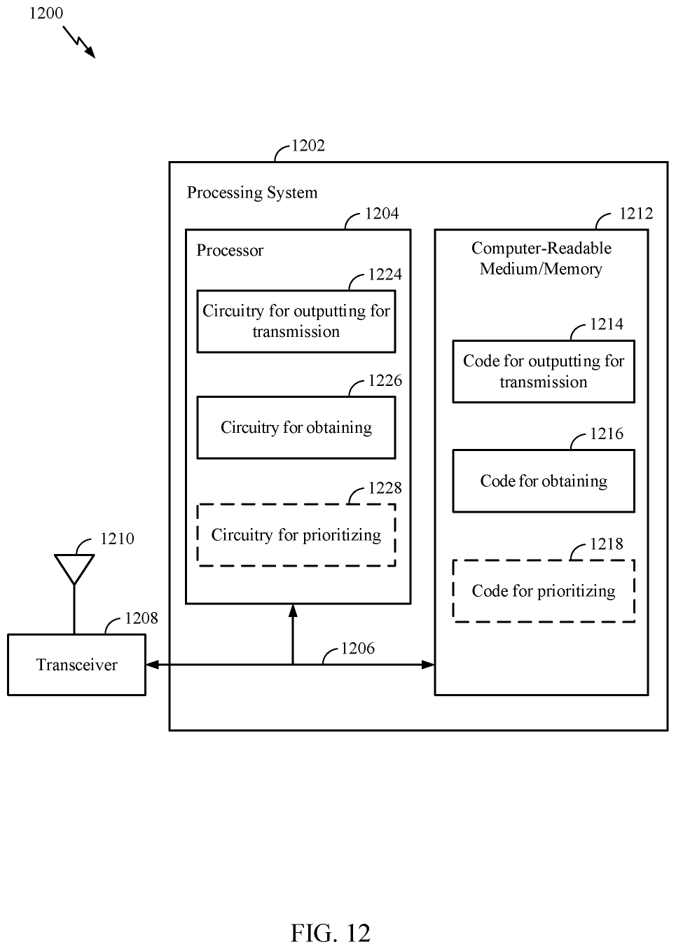

FIG. 12 illustrates a communications device 1200 that may include various components (e.g., corresponding to means-plus-function components) configured to perform operations for the techniques disclosed herein, such as the operations illustrated in FIGS. 7 and/or 8.

Communications device 1200 includes a processing system 1202 coupled to a transceiver 1208 (e.g., a transmitter and/or a receiver). Transceiver 1208 is configured to transmit and receive signals for the communications device 1200 via an antenna 1210, such as the various signals as described herein. Processing system 1202 may be configured to perform processing functions for communications device 1200, including processing signals received and/or to be transmitted by communications device 1200.

Processing system 1202 includes a processor 1204 coupled to a computer-readable medium/memory 1212 via a bus 1206. In certain aspects, computer-readable medium/memory 1212 is configured to store instructions (e.g., computer-executable code) that when executed by processor 1204, cause processor 1204 to perform the operations illustrated in FIGS. 7 and/or 8 or other operations for facilitating sidelink (SL) cross-link interference (CLI) measurements, as described herein. In some cases, the processor 1204 can include one or more components of UE 120a with reference to FIG. 2 such as, for example, controller/processor 280, transmit processor 264, receive processor 258, and/or the like. Additionally, in some cases, the computer-readable medium/memory 1212 can include one or more components of UE 120a with reference to FIG. 2 such as, for example, memory 282 and/or the like.

In certain aspects, computer-readable medium/memory 1212 stores code 1214 for outputting for transmission, code 1216 for obtaining, and code 1218 for prioritizing.

In some cases, code 1214 for outputting for transmission may include code for transmitting signaling to a first base station including: a request for resources to transmit one or more sidelink (SL) transmissions and an indication regarding a first SL transmission beam that the UE intends to use to transmit the one or more SL transmissions.

In some cases, code 1216 for obtaining may include code for receiving a grant for the resources to transmit the one or more SL transmissions, wherein the grant provides an indication regarding a second SL transmission beam to use for transmitting the one or more SL transmissions.

In some cases, code 1214 for outputting for transmission may include code for transmitting the one or more SL transmissions on the granted resources using the second SL transmission beam.

In some cases, code 1214 for outputting for transmission may include code for transmitting the indication regarding the first SL transmission beam in at least one of: a media access control control element (MAC CE) used for carrying a buffer status report; a media access control control element (MAC CE) that is separate from a MAC CE used for carrying a buffer status report; or radio resource control (RRC) signaling.

In some cases, code 1216 for obtaining may include code for receiving additional signaling from the first BS.

In some cases, code 1218 for prioritizing may include code for prioritizing, based on the received additional signaling, the one or more SL transmissions over other transmissions.

In some cases, code 1214 for outputting for transmission may include code for transmitting, based the received additional signaling, an indication to the first BS when the first UE is not able to perform the one or more SL transmissions based on the requested resources.

In certain aspects, processor 1204 has circuitry configured to implement the code stored in the computer-readable medium/memory 1212. For example, processor 1204 includes circuitry 1224 for outputting for transmission, circuitry 1226 for obtaining, and circuitry 1228 for prioritizing.

In some cases, circuitry 1224 for outputting for transmission may include circuitry for transmitting signaling to a first base station including: a request for resources to transmit one or more sidelink (SL) transmissions and an indication regarding a first SL transmission beam that the UE intends to use to transmit the one or more SL transmissions.

In some cases, circuitry 1226 for obtaining may include circuitry for receiving a grant for the resources to transmit the one or more SL transmissions, wherein the grant provides an indication regarding a second SL transmission beam to use for transmitting the one or more SL transmissions.

In some cases, circuitry 1224 for outputting for transmission may include circuitry for transmitting the one or more SL transmissions on the granted resources using the second SL transmission beam.

In some cases, circuitry 1224 for outputting for transmission may include circuitry for transmitting the indication regarding the first SL transmission beam in at least one of: a media access control control element (MAC CE) used for carrying a buffer status report; a media access control control element (MAC CE) that is separate from a MAC CE used for carrying a buffer status report; or radio resource control (RRC) signaling.

In some cases, circuitry 1226 for obtaining may include circuitry for receiving additional signaling from the first BS.

In some cases, circuitry 1228 for prioritizing may include circuitry for prioritizing, based on the received additional signaling, the one or more SL transmissions over other transmissions.

In some cases, circuitry 1224 for outputting for transmission may include circuitry for transmitting, based the received additional signaling, an indication to the first BS when the first UE is not able to perform the one or more SL transmissions based on the requested resources.

In some cases, the operations illustrated in FIGS. 7 and/or 8, as well as other operations described herein for facilitating SL CLI measurements, may be implemented by one or means-plus-function components. For example, in some cases, such operations may be implemented by means for transmitting (or means for outputting for transmission), means for receiving (or means for obtaining), and means for prioritizing.

In some cases, means for transmitting (or means for outputting for transmission) and means for receiving (or means or obtaining) include the transceiver 254 and/or antenna(s) 252 of the UE 120a illustrated in FIG. 2. Additionally, in some cases, means for transmitting (or means for outputting for transmission) includes circuitry 1224 for outputting for transmission of the communication device 1200 in FIG. 12. Additionally, in some cases, means for receiving (or means for obtaining) includes circuitry 1226 for obtaining of the communication device 1200 in FIG. 12.

In some cases, means for prioritizing includes a processing system, which may include one or more processors, such as the receive processor 258, the transmit processor 264, the TX MIMO processor 266, and/or the controller/processor 280 of the UE 120a illustrated in FIG. 2 and/or the processing system 1202 of the communication device 1200 in FIG. 12.

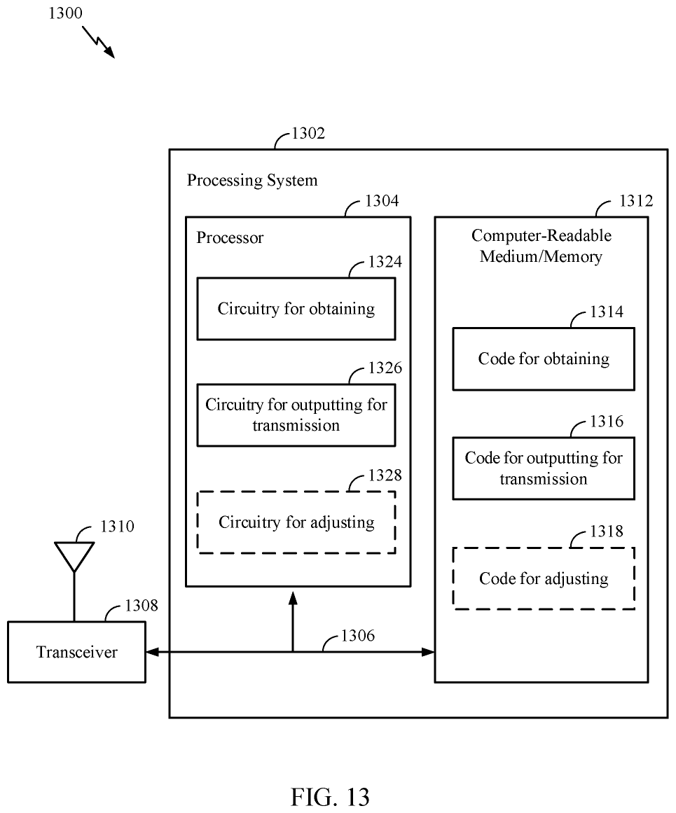

FIG. 13 illustrates a communications device 1300 that may include various components (e.g., corresponding to means-plus-function components) configured to perform operations for the techniques disclosed herein, such as the operations illustrated in FIGS. 7 and/or 9.

Communications device 1300 includes a processing system 1302 coupled to a transceiver 1308 (e.g., a transmitter and/or a receiver). Transceiver 1308 is configured to transmit and receive signals for the communications device 1300 via an antenna 1310, such as the various signals as described herein. Processing system 1302 may be configured to perform processing functions for communications device 1300, including processing signals received and/or to be transmitted by communications device 1300.

Processing system 1302 includes a processor 1304 coupled to a computer-readable medium/memory 1312 via a bus 1306. In certain aspects, computer-readable medium/memory 1312 is configured to store instructions (e.g., computer-executable code) that when executed by processor 1304, cause processor 1304 to perform the operations illustrated in FIGS. 7 and/or 9 or other operations for facilitating SL CLI measurements, as described herein. In some cases, the processor 1304 can include one or more components of BS 110a with reference to FIG. 2 such as, for example, controller/processor 240, transmit processor 220, receive processor 238, and/or the like. Additionally, in some cases, the computer-readable medium/memory 1312 can include one or more components of BS 110a with reference to FIG. 2 such as, for example, memory 242 and/or the like.

In certain aspects, computer-readable medium/memory 1312 stores code 1314 for obtaining, code 1316 for outputting for transmission, and code 1318 for adjusting.

In some cases, code 1314 for obtaining may include code for receiving signaling from a first UE including: a request for resources to transmit one or more sidelink (SL) transmissions and an indication regarding a first SL transmission beam that the UE intends to use to transmit the one or more SL transmissions.

In some cases, code 1316 for outputting for transmission may include code for transmitting a grant for the resources to transmit the one or more SL transmissions, wherein the grant provides an indication regarding a second SL transmission beam to use for transmitting the one or more SL transmissions.

In some cases, code 1316 for outputting for transmission may include code for transmitting signaling to a second base station indicating the resources for use by the first UE for transmitting the one or more SL transmissions.

In some cases, code 1314 for obtaining may include code for receiving signaling from the second base station indicating sidelink (SL) cross-link interference (CLI) measurements performed by a second UE associated with the second base station.

In some cases, code 1318 for adjusting may include code for adjusting, based on the received SL CLI measurements, at least one of: a time division duplexing (TDD) configuration associated with the first UE or one or more uplink transmission beams of the first UE.

In certain aspects, processor 1304 has circuitry configured to implement the code stored in the computer-readable medium/memory 1312. For example, processor 1304 includes circuitry 1324 for obtaining, circuitry 1326 for outputting for transmission, and circuitry 1328 for adjusting.

In some cases, circuitry 1324 for obtaining may include circuitry for receiving signaling from a first UE including: a request for resources to transmit one or more sidelink (SL) transmissions and an indication regarding a first SL transmission beam that the UE intends to use to transmit the one or more SL transmissions.

In some cases, circuitry 1326 for outputting for transmission may include circuitry for transmitting a grant for the resources to transmit the one or more SL transmissions, wherein the grant provides an indication regarding a second SL transmission beam to use for transmitting the one or more SL transmissions.

In some cases, circuitry 1326 for outputting for transmission may include circuitry for transmitting signaling to a second base station indicating the resources for use by the first UE for transmitting the one or more SL transmissions.

In some cases, circuitry 1324 for obtaining may include circuitry for receiving signaling from the second base station indicating sidelink (SL) cross-link interference (CLI) measurements performed by a second UE associated with the second base station.

In some cases, circuitry 1328 for adjusting may include circuitry for adjusting, based on the received SL CLI measurements, at least one of: a time division duplexing (TDD) configuration associated with the first UE or one or more uplink transmission beams of the first UE.

In some cases, the operations illustrated in FIGS. 7 and/or 9, as well as other operations described herein for facilitating SL CLI measurements, may be implemented by one or means-plus-function components. For example, in some cases, such operations may be implemented by means for transmitting (or means for outputting for transmission), means for receiving (or means for obtaining), and means for prioritizing.

In some cases, means for transmitting (or means for outputting for transmission) and means for receiving (or means or obtaining) include the transceiver 232 and/or antenna(s) 234 of the BS 110a illustrated in FIG. 2. Additionally, in some cases, means for transmitting (or means for outputting for transmission) includes circuitry 1326 for outputting for transmission of the communication device 1300 in FIG. 13. Additionally, in some cases, means for receiving (or means for obtaining) includes circuitry 1324 for obtaining of the communication device 1300 in FIG. 13.

In some cases, means for adjusting includes a processing system, which may include one or more processors, such as the receive processor 238, the transmit processor 220, the TX MIMO processor 230, and/or the controller/processor 240 of the BS 120a illustrated in FIG. 2 and/or the processing system 1302 of the communication device 1300 in FIG. 13.

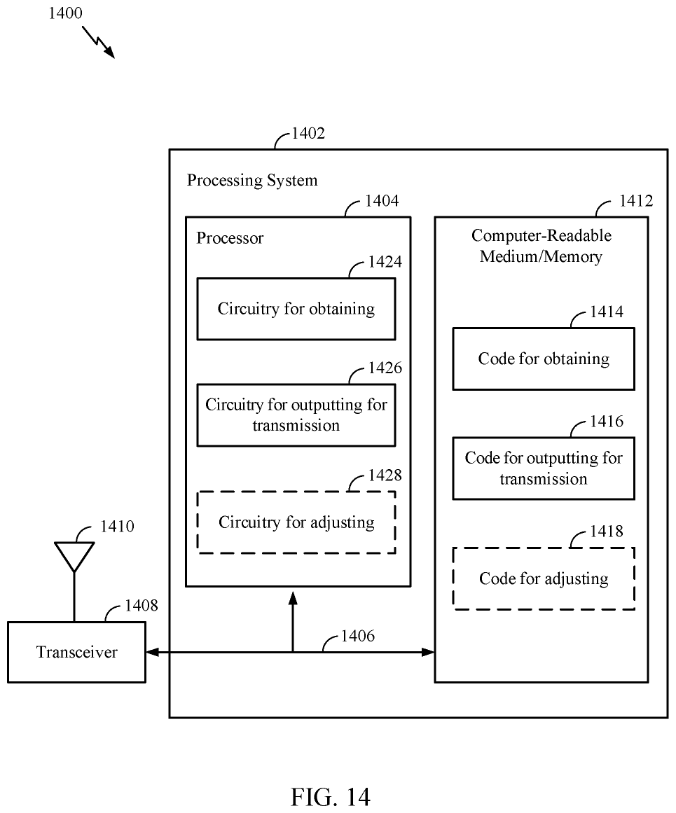

FIG. 14 illustrates a communications device 1400 that may include various components (e.g., corresponding to means-plus-function components) configured to perform operations for the techniques disclosed herein, such as the operations illustrated in FIGS. 7 and/or 10.

Communications device 1400 includes a processing system 1402 coupled to a transceiver 1408 (e.g., a transmitter and/or a receiver). Transceiver 1408 is configured to transmit and receive signals for the communications device 1400 via an antenna 1410, such as the various signals as described herein. Processing system 1402 may be configured to perform processing functions for communications device 1400, including processing signals received and/or to be transmitted by communications device 1400.

Processing system 1402 includes a processor 1404 coupled to a computer-readable medium/memory 1412 via a bus 1406. In certain aspects, computer-readable medium/memory 1412 is configured to store instructions (e.g., computer-executable code) that when executed by processor 1404, cause processor 1404 to perform the operations illustrated in FIGS. 7 and/or 10 or other operations for facilitating SL CLI measurements, as described herein. In some cases, the processor 1404 can include one or more components of BS 110a with reference to FIG. 2 such as, for example, controller/processor 240, transmit processor 220, receive processor 238, and/or the like. Additionally, in some cases, the computer-readable medium/memory 1412 can include one or more components of BS 110a with reference to FIG. 2 such as, for example, memory 242 and/or the like.

In certain aspects, computer-readable medium/memory 1412 stores code 1414 for obtaining, code 1416 for outputting for transmission, and code 1418 for adjusting.

In some cases, code 1414 for obtaining may include code for receiving signaling from a first base station indicating resources for use by a first UE, associated with the first base station, for transmitting one or more SL transmissions.

In some cases, code 1416 for outputting for transmission may include code for transmitting, based on the signaling from the first base station, a sidelink (SL) cross-link interference (CLI) configuration to a second UE associated with the second BS indicating resources for performing SL CLI measurements on the resources used by the first UE for transmitting one or more SL transmissions.

In some cases, code 1414 for obtaining may include code for receiving the SL CLI measurements from the second UE.

In some cases, code 1418 for adjusting may include code for adjusting, based on the received SL CLI measurements, at least one of: a time division duplexing (TDD) configuration associated with the second UE or one or more downlink transmission configuration indicator (TCI) states of the second UE.

In some cases, code 1416 for outputting for transmission may include code for transmitting signaling to the first base station indicating the SL CLI measurements.

In certain aspects, processor 1404 has circuitry configured to implement the code stored in the computer-readable medium/memory 1412. For example, processor 1404 includes circuitry 1424 for obtaining, circuitry 1426 for outputting for transmission, and circuitry 1428 for adjusting.

In some cases, circuitry 1424 for obtaining may include circuitry for receiving signaling from a first base station indicating resources for use by a first UE, associated with the first base station, for transmitting one or more SL transmissions.

In some cases, circuitry 1426 for outputting for transmission may include circuitry for transmitting, based on the signaling from the first base station, a sidelink (SL) cross-link interference (CLI) configuration to a second UE associated with the second BS indicating resources for performing SL CLI measurements on the resources used by the first UE for transmitting one or more SL transmissions.

In some cases, circuitry 1424 for obtaining may include circuitry for receiving the SL CLI measurements from the second UE.

In some cases, circuitry 1428 for adjusting may include circuitry for adjusting, based on the received SL CLI measurements, at least one of: a time division duplexing (TDD) configuration associated with the second UE or one or more downlink transmission configuration indicator (TCI) states of the second UE.

In some cases, circuitry 1426 for outputting for transmission may include circuitry for transmitting signaling to the first base station indicating the SL CLI measurements.

In some cases, the operations illustrated in FIGS. 7 and/or 10, as well as other operations described herein for facilitating SL CLI measurements, may be implemented by one or means-plus-function components. For example, in some cases, such operations may be implemented by means for transmitting (or means for outputting for transmission), means for receiving (or means for obtaining), and means for prioritizing.

In some cases, means for transmitting (or means for outputting for transmission) and means for receiving (or means or obtaining) include the transceiver 232 and/or antenna(s) 234 of the BS 110a illustrated in FIG. 2. Additionally, in some cases, means for transmitting (or means for outputting for transmission) includes circuitry 1426 for outputting for transmission of the communication device 1400 in FIG. 14. Additionally, in some cases, means for receiving (or means for obtaining) includes circuitry 1424 for obtaining of the communication device 1400 in FIG. 14.

In some cases, means for adjusting includes a processing system, which may include one or more processors, such as the receive processor 238, the transmit processor 220, the TX MIMO processor 230, and/or the controller/processor 240 of the BS 120a illustrated in FIG. 2 and/or the processing system 1402 of the communication device 1400 in FIG. 14.

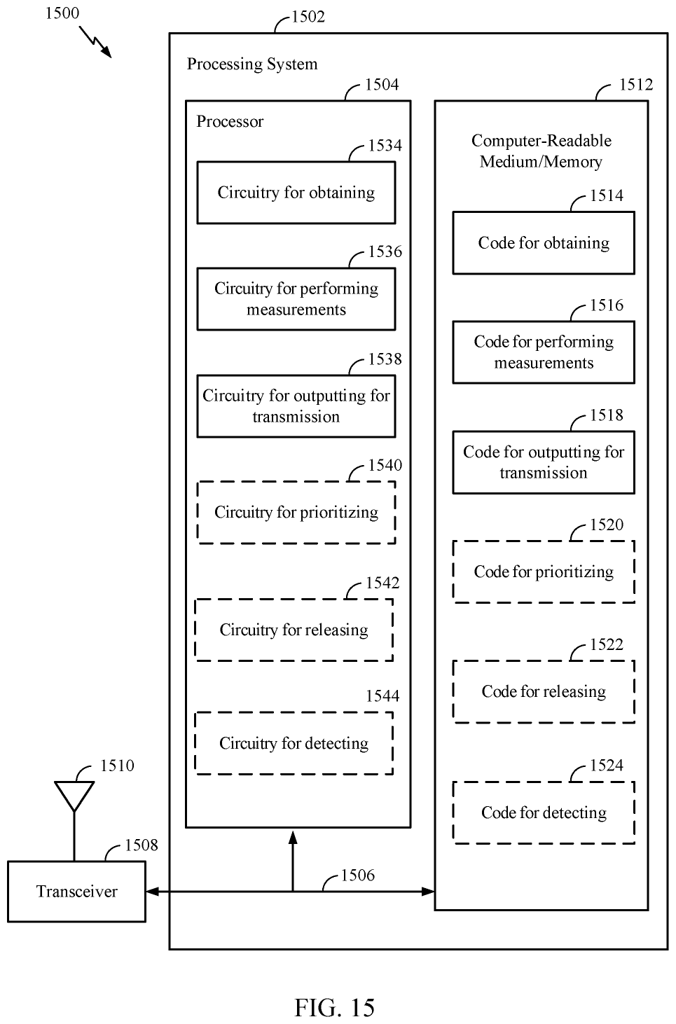

FIG. 15 illustrates a communications device 1500 that may include various components (e.g., corresponding to means-plus-function components) configured to perform operations for the techniques disclosed herein, such as the operations illustrated in FIGS. 7 and/or 11.

Communications device 1500 includes a processing system 1502 coupled to a transceiver 1508 (e.g., a transmitter and/or a receiver). Transceiver 1508 is configured to transmit and receive signals for the communications device 1500 via an antenna 1510, such as the various signals as described herein. Processing system 1502 may be configured to perform processing functions for communications device 1500, including processing signals received and/or to be transmitted by communications device 1500.

Processing system 1502 includes a processor 1504 coupled to a computer-readable medium/memory 1512 via a bus 1506. In certain aspects, computer-readable medium/memory 1512 is configured to store instructions (e.g., computer-executable code) that when executed by processor 1504, cause processor 1504 to perform the operations illustrated in FIGS. 7 and/or 11 or other operations for facilitating sidelink (SL) cross-link interference (CLI) measurements, as described herein. In some cases, the processor 1504 can include one or more components of UE 120a with reference to FIG. 2 such as, for example, controller/processor 280, transmit processor 264, receive processor 258, and/or the like. Additionally, in some cases, the computer-readable medium/memory 1512 can include one or more components of UE 120a with reference to FIG. 2 such as, for example, memory 282 and/or the like.

In certain aspects, computer-readable medium/memory 1512 stores code 1514 for obtaining, code 1516 for performing measurements, code 1518 for outputting for transmission, code 1520 for prioritizing, code 1522 for releasing, and code 1524 for detecting.

In some cases, code 1514 for obtaining may include code for receiving a sidelink (SL) cross-link interference (CLI) configuration from a second base station indicating resources for performing the SL CLI measurements.

In some cases, code 1516 for performing measurements may include code for performing the SL CLI measurements on the resources indicated in the SL CLI configuration.

In some cases, code 1518 for outputting for transmission may include code for transmitting a report to the second base station indicating the SL CLI measurements.

In some cases, code 1516 for performing measurements may include code for measuring a reference signal received power (RSRP) of one or more demodulation reference signals (DMRSs) transmitted on a sidelink control channel by a first UE associated with a first BS.

In some cases, code 1516 for performing measurements may include code for measuring a received signal strength indicator (RS SI) on time and frequency resources for at least one of a control channel or a data channel via which a first UE associated with a first BS transmits.

In some cases, code 1516 for performing measurements may include code for measuring a first reference signal received power (RSRP) of one or more demodulation reference signals (DMRSs) transmitted on a sidelink control channel by a first UE associated with a first BS.

In some cases, code 1516 for performing measurements may include code for measuring a second RSRP of one or more DMRSs transmitted on a sidelink data channel by the first UE associated with the first BS.

In some cases, code 1516 for performing measurements may include code for measuring reference signal received power (RSRP) of one or more channel state information reference signals (CSI-RSs) transmitted by a first UE associated with a first BS.

In some cases, code 1518 for outputting for transmission may include code for transmitting signaling to the second BS indicating a capability of the second UE for performing the SL CLI measurements.

In some cases, code 1514 for obtaining may include code for receiving a CLI received signal strength indicator (RSSI) configuration indicating resources for performing CLI RSSI measurements associated with the second BS.

In some cases, code 1514 for obtaining may include code for receiving a CLI sounding reference signal (SRS) configuration indicating resources for performing CLI measurements on one or more SRSs associated with the second BS.

In some cases, code 1520 for prioritizing may include code for prioritizing, based on an overlap between at least one of the CLI RSSI configuration or the CLI SRS configuration and the SL CLI configuration, measurements associated with the CLI RSSI configuration or measurements associated with the CLI SRS configuration over measurements associated with the SL CLI configuration.

In some cases, code 1522 for releasing may include code for releasing, based on the received SL CLI configuration, at least one of the resources associated with the CLI RSSI configuration or the resources associated with the CLI SRS configuration.

In some cases, code 1514 for obtaining may include code for receiving timing information for performing the SL CLI measurements, wherein the SL CLI measurements is performed based on the timing information.

In some cases, code 1516 for performing measurements may include code for performing the SL CLI measurements on the resources regardless of whether a first UE associated with a first BS is performing one or more SL transmissions on the resources for performing the SL CLI measurements.

In some cases, code 1524 for detecting may include code for detecting a presence or an absence of one or more SL transmissions on the resources.

In some cases, code 1518 for outputting for transmission may include code for transmitting the report to the second base station indicating the SL CLI measurements only when the presence of the one or more SL transmissions on the resources is detected.

In some cases, code 1524 for detecting may include code for detecting the absence of the one or more SL transmissions on the resources.

In some cases, code 1518 for outputting for transmission may include code for transmitting an indication of the absence of the one or more SL transmissions on the resources.

In certain aspects, processor 1504 has circuitry configured to implement the code stored in the computer-readable medium/memory 1512. For example, processor 1504 includes circuitry 1534 for obtaining, circuitry 1536 for performing measurements, circuitry 1538 for outputting for transmission, circuitry 1540 for prioritizing, circuitry 1542 for releasing, and circuitry 1544 for detecting.

In some cases, circuitry 1534 for obtaining may include circuitry for receiving a sidelink (SL) cross-link interference (CLI) configuration from a second base station indicating resources for performing the SL CLI measurements.

In some cases, circuitry 1536 for performing measurements may include circuitry for performing the SL CLI measurements on the resources indicated in the SL CLI configuration.

In some cases, circuitry 1538 for outputting for transmission may include circuitry for transmitting a report to the second base station indicating the SL CLI measurements.

In some cases, circuitry 1536 for performing measurements may include circuitry for measuring a reference signal received power (RSRP) of one or more demodulation reference signals (DMRSs) transmitted on a sidelink control channel by a first UE associated with a first BS.

In some cases, circuitry 1536 for performing measurements may include circuitry for measuring a received signal strength indicator (RSSI) on time and frequency resources for at least one of a control channel or a data channel via which a first UE associated with a first BS transmits.

In some cases, circuitry 1536 for performing measurements may include circuitry for measuring a first reference signal received power (RSRP) of one or more demodulation reference signals (DMRSs) transmitted on a sidelink control channel by a first UE associated with a first BS.

In some cases, circuitry 1536 for performing measurements may include circuitry for measuring a second RSRP of one or more DMRSs transmitted on a sidelink data channel by the first UE associated with the first BS.

In some cases, circuitry 1536 for performing measurements may include circuitry for measuring reference signal received power (RSRP) of one or more channel state information reference signals (CSI-RSs) transmitted by a first UE associated with a first B S.

In some cases, circuitry 1538 for outputting for transmission may include circuitry for transmitting signaling to the second BS indicating a capability of the second UE for performing the SL CLI measurements.

In some cases, circuitry 1534 for obtaining may include circuitry for receiving a CLI received signal strength indicator (RSSI) configuration indicating resources for performing CLI RS SI measurements associated with the second BS.

In some cases, circuitry 1534 for obtaining may include circuitry for receiving a CLI sounding reference signal (SRS) configuration indicating resources for performing CLI measurements on one or more SRSs associated with the second BS.

In some cases, circuitry 1540 for prioritizing may include circuitry for prioritizing, based on an overlap between at least one of the CLI RSSI configuration or the CLI SRS configuration and the SL CLI configuration, measurements associated with the CLI RSSI configuration or measurements associated with the CLI SRS configuration over measurements associated with the SL CLI configuration.

In some cases, circuitry 1542 for releasing may include circuitry for releasing, based on the received SL CLI configuration, at least one of the resources associated with the CLI RS SI configuration or the resources associated with the CLI SRS configuration.

In some cases, circuitry 1534 for obtaining may include circuitry for receiving timing information for performing the SL CLI measurements, wherein the SL CLI measurements is performed based on the timing information.

In some cases, circuitry 15316 for performing measurements may include circuitry for performing the SL CLI measurements on the resources regardless of whether a first UE associated with a first BS is performing one or more SL transmissions on the resources for performing the SL CLI measurements.

In some cases, circuitry 1544 for detecting may include circuitry for detecting a presence or an absence of one or more SL transmissions on the resources.

In some cases, circuitry 1538 for outputting for transmission may include circuitry for transmitting the report to the second base station indicating the SL CLI measurements only when the presence of the one or more SL transmissions on the resources is detected.

In some cases, circuitry 1544 for detecting may include circuitry for detecting the absence of the one or more SL transmissions on the resources.

In some cases, circuitry 1538 for outputting for transmission may include circuitry for transmitting an indication of the absence of the one or more SL transmissions on the resources.

In some cases, the operations illustrated in FIGS. 7 and/or 11, as well as other operations described herein for facilitating SL CLI measurements, may be implemented by one or means-plus-function components. For example, in some cases, such operations may be implemented by means for transmitting (or means for outputting for transmission), means for receiving (or means for obtaining), means for performing measurements, means for prioritizing, means for releasing, and means for detecting.

In some cases, means for transmitting (or means for outputting for transmission) and means for receiving (or means or obtaining) include the transceiver 254 and/or antenna(s) 252 of the UE 120a illustrated in FIG. 2. Additionally, in some cases, means for transmitting (or means for outputting for transmission) includes circuitry 1524 for transmitting of the communication device 1500 in FIG. 15. Additionally, in some cases, means for receiving (or means for obtaining) includes circuitry 1526 for receiving of the communication device 1500 in FIG. 15.

In some cases, means for performing measurements, means for releasing, means for detecting, and means for prioritizing includes a processing system, which may include one or more processors, such as the receive processor 258, the transmit processor 264, the TX MIMO processor 266, and/or the controller/processor 280 of the UE 120a illustrated in FIG. 2 and/or the processing system 1502 of the communication device 1500 in FIG. 15.

### Example Clauses

Clause 1: A method for wireless communications by a first user equipment (UE), comprising: transmitting signaling to a first base station including: a request for resources to transmit one or more sidelink (SL) transmissions and an indication regarding a first SL transmission beam that the UE intends to use to transmit the one or more SL transmissions; receiving a grant for the resources to transmit the one or more SL transmissions, wherein the grant provides an indication regarding a second SL transmission beam to use for transmitting the one or more SL transmissions; and transmitting the one or more SL transmissions on the granted resources using the second SL transmission beam.

Clause 2: The method of Clause 1, wherein the request comprises a buffer status report and the one or more SL transmissions comprise SL control and data transmissions.

Clause 3: The method of any of Clauses 1-2, wherein the indication regarding the first SL transmission beam comprises at least one of: a beam index of the first SL transmission beam; a transmission configuration indicator (TCI) state associated with the first SL transmission beam; or an indication of a quasi colocated (QCL) relationship between the first SL transmission beam and an uplink transmission beam used for uplink transmissions to the first base station, wherein the uplink transmission beam associated with a sounding reference signal resource index (SRI).

Clause 4: The method of any of Clauses 1-3, wherein transmitting the signaling comprising the indication regarding the first SL transmission beam comprises transmitting the indication regarding the first SL transmission beam in at least one of: a media access control control element (MAC CE) used for carrying a buffer status report; a media access control control element (MAC CE) that is separate from a MAC CE used for carrying a buffer status report; or radio resource control (RRC) signaling.

Clause 5: The method of any of Clauses 1-5, wherein the second SL transmission beam to use for transmitting the one or more SL transmissions indicated by the received grant comprises the first SL transmission beam or an uplink transmission beam that has a quasi colocated (QCL) relationship with the first SL transmission beam.

Clause 6: The method of any of Clauses 1-5, the second SL transmission beam comprises the first SL transmission beam indicated by the first UE when the grant does not include an explicit indication of the second SL transmission beam.

Clause 7: The method of any of Clauses 1-6, wherein the grant is a semi-persistently scheduled (SPS) grant.

Clause 8: The method of any of Clauses 1-7, wherein the one or more SL transmissions comprise at least one of SL demodulation reference signals (DMRSs) or SL channel state information reference signals (CSI-RSs).

Clause 9: The method of any of Clauses 1-8, further comprising: receiving additional signaling from the first BS; and prioritizing, based on the received additional signaling, the one or more SL transmissions over other transmissions; or transmitting, based the received additional signaling, an indication to the first BS when the first UE is not able to perform the one or more SL transmissions based on the requested resources.

Clause 10: A method for wireless communication by a first base station (BS), comprising: receiving signaling from a first user equipment (UE) including: a request for resources to transmit one or more sidelink (SL) transmissions and an indication regarding a first SL transmission beam that the UE intends to use to transmit the one or more SL transmissions; transmitting a grant for the resources to transmit the one or more SL transmissions, wherein the grant provides an indication regarding a second SL transmission beam to use for transmitting the one or more SL transmissions; and transmitting signaling to a second base station indicating the resources for use by the first UE for transmitting the one or more SL transmissions.

Clause 11: The method of Clause 10, wherein the indication regarding the first SL transmission beam comprises at least one of: a beam index of the first SL transmission beam; a transmission configuration indicator (TCI) state associated with the first SL transmission beam; or an indication of a quasi colocated (QCL) relationship between the first SL transmission beam and an uplink transmission beam used for uplink transmissions to the first base station, wherein the uplink transmission beam associated with a sounding reference signal resource index (SRI).

Clause 12: The method of Clause 11, wherein the second SL transmission beam to use for transmitting the one or more SL transmissions indicated by the transmitted grant comprises the first SL transmission beam or the uplink transmission beam that has the QCL relationship with the first SL transmission beam.

Clause 13: The method of any of Clauses 10-12, wherein the request comprises a buffer status report and the one or more SL transmissions comprise SL control and data transmissions.

Clause 14: The method of any of Clauses 10-13, wherein receiving the signaling comprising the indication regarding the first SL transmission beam comprises receiving the indication regarding the first SL transmission beam in at least one of: a media access control control element (MAC CE) used for carrying a buffer status report; a media access control control element (MAC CE) that is separate from a MAC CE used for carrying a buffer status report; or radio resource control (RRC) signaling.

Clause 15: The method of any of Clauses 10-14, the second SL transmission beam comprises the first SL transmission beam indicated by the first UE when the grant does not include an explicit indication of the second SL transmission beam.

Clause 16: The method of any of Clauses 10-15, wherein the grant is a semi-persistently scheduled (SPS) grant.

Clause 17: The method of any of Clauses 10-16, wherein the one or more SL transmissions comprise at least one of SL demodulation reference signals (DMRSs) or SL channel state information reference signals (CSI-RSs).

Clause 18. The method of any of Clauses 10-18, further comprising: receiving signaling from the second base station indicating sidelink (SL) cross-link interference (CLI) measurements performed by a second UE associated with the second base station; and adjusting, based on the received SL CLI measurements, at least one of: a time division duplexing (TDD) configuration associated with the first UE; or one or more uplink transmission beams of the first UE.

Clause 19: The method of any of Clauses 10-18, further comprising transmitting additional signaling for configuring the first UE to: prioritize the one or more SL transmissions over other transmissions; or transmit an indication to the first BS when the first UE is not able to perform the one or more SL transmissions on the resources.

Clause 20: A method for wireless communication by a second base station (BS), comprising: receiving signaling from a first base station indicating resources for use by a first UE, associated with the first base station, for transmitting one or more SL transmissions; transmitting, based on the signaling from the first base station, a sidelink (SL) cross-link interference (CLI) configuration to a second UE associated with the second BS indicating resources for performing SL CLI measurements on the resources used by the first UE for transmitting one or more SL transmissions; and receiving the SL CLI measurements from the second UE.

Clause 21: The method of Clause 20, further comprising adjusting, based on the received SL CLI measurements, at least one of: a time division duplexing (TDD) configuration associated with the second UE; or one or more downlink transmission configuration indicator (TCI) states of the second UE.

Clause 22: The method of any of Clauses 20-21, further comprising transmitting signaling to the first base station indicating the SL CLI measurements.

Clause 23: The method of any of Clauses 20-22, wherein the resources for performing the SL CLI measurements comprise one of: time and frequency resources for a sidelink control channel and a sidelink data channel; time and frequency resources for only a sidelink data channel; or resources for receiving one or more channel state information reference signals (CSI-RSs).

Clause 24: The method of any of Clauses 20-24, further comprising receiving signaling from the second UE indicating a capability of the second UE for performing the SL CLI measurements.

Clause 25: The method of Clause 24, wherein the capability of the second UE for performing the SL CLI measurements indicates one of: a capability for performing reference signal received power (RSRP) measurements on demodulation reference signals (DMRSs) transmitted on at least one of a SL control channel or a SL data channel; or a capability for performing reference signal received power (RSRP) measurements on SL channel state information reference signals (CSI-RSs).

Clause 26. The method of any of Clauses 20-25, further comprising transmitting, to the second UE, at least one of: a CLI received signal strength indicator (RSSI) configuration indicating resources for performing CLI RSSI measurements associated with the second BS or a CLI sounding reference signal (SRS) configuration indicating resources for performing CLI measurements on one or more SRSs associated with the second BS.

Clause 27. The method of any of Clauses 20-26, wherein: the SL CSI configuration further indicates a downlink transmission configuration indicator (TCI) state.

Clause 28. The method of any of Clauses 20-27, further comprising transmitting, to the second UE, timing information for performing the SL CLI measurements, wherein the SL CLI measurements is performed based on the timing information.

Clause 29: The method of Clause 28, wherein the timing information comprises one of: a downlink timing advance that is approximately equal to an uplink timing advance used by a first UE for transmissions on the resources used for performing the SL CLI measurements; a SL timing reference based on a global navigation satellite system (GNSS) time; or a SL timing reference received from a first UE that has a SL connection with the second UE and wherein the SL CLI configuration includes a source identifier (ID) associated with the first UE.

Clause 30. The method of any of Clauses 20-29, wherein receiving the report from the second UE indicating the SL CLI measurements comprises receiving the report from the second UE indicating the SL CLI measurements only when presence of the one or more SL transmissions on the resources is detected by the second UE.

Clause 31: The method of Clause 30, wherein receiving the report from the second UE indicating the SL CLI measurements comprises receiving an indication of an absence of the one or more SL transmissions on the resources.

Clause 32: A method for wireless communications by a second user equipment (UE), comprising: receiving a sidelink (SL) cross-link interference (CLI) configuration from a second base station indicating resources for performing the SL CLI measurements; performing the SL CLI measurements on the resources indicated in the SL CLI configuration; and transmitting a report to the second base station indicating the SL CLI measurements.

Clause 33: The method of Clause 32, wherein the resources for performing the SL CLI measurements comprise one of: time and frequency resources for a sidelink control channel and a sidelink data channel; time and frequency resources for only a sidelink data channel; or resources for receiving one or more channel state information reference signals (CSI-RSs).

Clause 34: The method of any of Clauses 32-33, wherein performing the SL CLI measurements comprises measuring a reference signal received power (RSRP) of one or more demodulation reference signals (DMRSs) transmitted on a sidelink control channel by a first UE associated with a first BS.

Clause 35: The method of any of Clauses 32-34, wherein performing the SL CLI measurements comprises measuring a received signal strength indicator (RSSI) on time and frequency resources for at least one of a control channel or a data channel via which a first UE associated with a first BS transmits.

Clause 36: The method of any of Clauses 32-35, wherein performing the SL CLI measurements comprises: measuring a first reference signal received power (RSRP) of one or more demodulation reference signals (DMRSs) transmitted on a sidelink control channel by a first UE associated with a first BS; and measuring a second RSRP of one or more DMRSs transmitted on a sidelink data channel by the first UE associated with the first BS.

Clause 37: The method of any of Clauses 32-36, wherein performing the SL CLI measurements comprises measuring reference signal received power (RSRP) of one or more channel state information reference signals (CSI-RSs) transmitted by a first UE associated with a first BS.

Clause 38: The method of any of Clauses 32-37, further comprising transmitting signaling to the second BS indicating a capability of the second UE for performing the SL CLI measurements.

Clause 39: The method of Clause 38, wherein the capability of the second UE for performing the SL CLI measurements indicates one of: a capability for performing reference signal received power (RSRP) measurements on demodulation reference signals (DMRSs) transmitted on at least one of a SL control channel or a SL data channel; or a capability for performing reference signal received power (RSRP) measurements on SL channel state information reference signals (CSI-RSs).

Clause 40: The method of any of Clauses 32-39, further comprising receiving at least one of: a CLI received signal strength indicator (RSSI) configuration indicating resources for performing CLI RSSI measurements associated with the second BS; or a CLI sounding reference signal (SRS) configuration indicating resources for performing CLI measurements on one or more SRSs associated with the second BS.

Clause 41: The method of Clause 40, wherein: at least one of the CLI RSSI configuration or the CLI SRS configuration overlaps the SL CLI configuration; and the method further comprises prioritizing, based on the overlap, measurements associated with the CLI RSSI configuration or measurements associated with the CLI SRS configuration over measurements associated with the SL CLI configuration.

Clause 42: The method of Clause 40, further comprising releasing, based on the received SL CLI configuration, at least one of the resources associated with the CLI RSSI configuration or the resources associated with the CLI SRS configuration.

Clause 43: The method of any of Clauses 32-42, wherein: the SL CSI configuration further indicates a downlink transmission configuration indicator (TCI) state; and performing SL CLI measurements by using a receive beam associated with the indicated downlink TCI state.

Clause 44: The method of any of Clauses 32-43, further comprising receiving timing information for performing the SL CLI measurements, wherein the SL CLI measurements is performed based on the timing information.

Clause 45: The method of Clause 44, wherein the timing information comprises one of: a downlink timing advance that is approximately equal to an uplink timing advance used by a first UE for transmissions on the resources used for performing the SL CLI measurements; a SL timing reference based on a global navigation satellite system (GNSS) time; or a SL timing reference received from a first UE that has a SL connection with the second UE and wherein the SL CLI configuration includes a source identifier (ID) associated with the first UE.

Clause 46: The method of any of Clauses 32-45, wherein performing the SL CLI measurements on the resources indicated in the SL CLI configuration comprises performing the SL CLI measurements on the resources regardless of whether a first UE associated with a first BS is performing one or more SL transmissions on the resources for performing the SL CLI measurements.

Clause 47: The method of any of Clauses 32-46, wherein: performing the SL CLI measurements on the resources indicated in the SL CLI configuration comprises detecting a presence or an absence of one or more SL transmissions on the resources; and transmitting the report to the second base station indicating the SL CLI measurements comprises transmitting the report to the second base station indicating the SL CLI measurements only when the presence of the one or more SL transmissions on the resources is detected.

Clause 48: The method of Clause 47, wherein: detecting the presence or the absence of the one or more SL transmissions on the resources comprises detecting the absence of the one or more SL transmissions on the resources; and transmitting the report to the second base station indicating the SL CLI measurements comprises transmitting an indication of the absence of the one or more SL transmissions on the resources.

Clause 49: The method of Clause 47, wherein detecting the presence of the one or more transmissions on the resources is based on at least one of: successful decoding of the one or more SL transmissions on the resources; or a reference signal received power (RSRP) or a received signal strength indicator (RSSI) associated with the resources being greater than or equal to a threshold.

Clause 50: A first UE, comprising means for performing the operations of one or more of Clauses 1-9.

Clause 51: A first UE, comprising a transceiver and processing system including at least one processor configured to perform the operations of one or more of Clauses 1-9.

Clause 52: An apparatus for wireless communications, comprising one or more interfaces and a processing system including at least one processor configured to perform the operations of one or more of Clauses 1-9.

Clause 53: A computer-readable medium for wireless communications, comprising codes executable to perform the operations of one or more of Clauses 1-9.

Clause 54: A first BS, comprising means for performing the operations of one or more of Clauses 10-19.

Clause 55: A first BS, comprising a transceiver and processing system including at least one processor configured to perform the operations of one or more of Clauses 10-19.

Clause 56: An apparatus for wireless communications, comprising one or more interfaces and a processing system including at least one processor configured to perform the operations of one or more of Clauses 10-19.

Clause 57: A computer-readable medium for wireless communications, comprising codes executable to perform the operations of one or more of Clauses 10-19.

Clause 58: A second BS, comprising means for performing the operations of one or more of Clauses 20-31.

Clause 55: A second BS, comprising a transceiver and processing system including at least one processor configured to perform the operations of one or more of Clauses 20-31.

Clause 56: An apparatus for wireless communications, comprising one or more interfaces and a processing system including at least one processor configured to perform the operations of one or more of Clauses 20-31.

Clause 57: A computer-readable medium for wireless communications, comprising codes executable to perform the operations of one or more of Clauses 20-31.

Clause 50: A second UE, comprising means for performing the operations of one or more of Clauses 32-49.

Clause 51: A second UE, comprising a transceiver and processing system including at least one processor configured to perform the operations of one or more of Clauses 32-49.

Clause 52: An apparatus for wireless communications, comprising one or more interfaces and a processing system including at least one processor configured to perform the operations of one or more of Clauses 32-49.

Clause 53: A computer-readable medium for wireless communications, comprising codes executable to perform the operations of one or more of Clauses 32-49.

### ADDITIONAL CONSIDERATIONS

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. ABS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIGS. 7-11 and/or other operations described herein for facilitating sidelink (SL) cross-link interference (CLI) measurements.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A first user equipment (UE), comprising:
a transceiver configured to:
transmit signaling to a first base station including:
a request for resources to transmit one or more sidelink (SL) transmissions; and
an indication regarding a first SL transmission beam that the UE intends to use to transmit the one or more SL transmissions;
receive a grant for the resources to transmit the one or more SL transmissions, wherein the grant provides an indication regarding a second SL transmission beam to use for transmitting the one or more SL transmissions; and
transmit the one or more SL transmissions on the granted resources using the second SL transmission beam.

2. The first UE of claim 1, wherein the request comprises a buffer status report and the one or more SL transmissions comprise SL control and data transmissions.

3. The first UE of claim 1, wherein the indication regarding the first SL transmission beam comprises at least one of:
a beam index of the first SL transmission beam;
a transmission configuration indicator (TCI) state associated with the first SL transmission beam; or
an indication of a quasi colocated (QCL) relationship between the first SL transmission beam and an uplink transmission beam used for uplink transmissions to the first base station, wherein the uplink transmission beam associated with a sounding reference signal resource index (SRI).

4. The first UE of claim 1, wherein the transceiver if further configured to transmit the indication regarding the first SL transmission beam in at least one of:
a media access control control element (MAC CE) used for carrying a buffer status report;
a media access control control element (MAC CE) that is separate from a MAC CE used for carrying a buffer status report; or
radio resource control (RRC) signaling.

5. The first UE of claim 1, wherein the second SL transmission beam to use for transmitting the one or more SL transmissions indicated by the received grant comprises the first SL transmission beam or an uplink transmission beam that has a quasi colocated (QCL) relationship with the first SL transmission beam.

6. The first UE of claim 1, the second SL transmission beam comprises the first SL transmission beam indicated by the first UE when the grant does not include an explicit indication of the second SL transmission beam.

7. The first UE of claim 1, wherein the one or more SL transmissions comprise at least one of SL demodulation reference signals (DMRSs) or SL channel state information reference signals (CSI-RSs).

8. The first UE of claim 1, wherein:
the transceiver is further configured to receive additional signaling from the first BS; and
the first UE further comprises a processing system including at least one processor configured to prioritize, based on the received additional signaling, the one or more SL transmissions over other transmissions; or
the transceiver is further configured to transmit, based the received additional signaling, an indication to the first BS when the first UE is not able to perform the one or more SL transmissions based on the requested resources.

9. A first base station (BS), comprising:
a transceiver configured to:
receive signaling from a first user equipment (UE) including:
a request for resources to transmit one or more sidelink (SL) transmissions; and
an indication regarding a first SL transmission beam that the UE intends to use to transmit the one or more SL transmissions;
transmit a grant for the resources to transmit the one or more SL transmissions, wherein the grant provides an indication regarding a second SL transmission beam to use for transmitting the one or more SL transmissions; and
transmit signaling to a second base station indicating the resources for use by the first UE for transmitting the one or more SL transmissions.

10. The first BS of claim 9, wherein the indication regarding the first SL transmission beam comprises at least one of:
a beam index of the first SL transmission beam;
a transmission configuration indicator (TCI) state associated with the first SL transmission beam; or
an indication of a quasi colocated (QCL) relationship between the first SL transmission beam and an uplink transmission beam used for uplink transmissions to the first base station, wherein the uplink transmission beam associated with a sounding reference signal resource index (SRI).

11. The first BS of claim 10, wherein the second SL transmission beam to use for transmitting the one or more SL transmissions indicated by the transmitted grant comprises the first SL transmission beam or the uplink transmission beam that has the QCL relationship with the first SL transmission beam.

12. The first BS of claim 9, wherein:
the transceiver is further configured to receive signaling from the second base station indicating sidelink (SL) cross-link interference (CLI) measurements performed by a second UE associated with the second base station; and
the first BS further comprises a processing system including at least one processor configured to adjust, based on the received SL CLI measurements, at least one of:
a time division duplexing (TDD) configuration associated with the first UE; or
one or more uplink transmission beams of the first UE.

13. The first BS of claim 9, wherein the transceiver is further configured to transmit additional signaling for configuring the first UE to:
prioritize the one or more SL transmissions over other transmissions; or
transmit an indication to the first BS when the first UE is not able to perform the one or more SL transmissions on the resources.

14. A second base station (BS), comprising:
a transceiver configured to:
receive signaling from a first base station indicating resources for use by a first UE, associated with the first base station, for transmitting one or more SL transmissions;
transmit, based on the signaling from the first base station, a sidelink (SL) cross-link interference (CLI) configuration to a second UE associated with the second BS indicating resources for performing SL CLI measurements on the resources used by the first UE for transmitting one or more SL transmissions; and
receive the SL CLI measurements from the second UE.

15. The second BS of claim 14, wherein the second BS further comprises a processing system including at least one processor configured to adjust, based on the received SL CLI measurements, at least one of:
a time division duplexing (TDD) configuration associated with the second UE; or
one or more downlink transmission configuration indicator (TCI) states of the second UE.

16. The second BS of claim 14, wherein the transceiver is further configured to transmit signaling to the first base station indicating the SL CLI measurements.

17. A second user equipment (UE), comprising:
a transceiver configured to receive a sidelink (SL) cross-link interference (CLI) configuration from a second base station indicating resources for performing the SL CLI measurements; and
a processing system including at least one processor configured to perform the SL CLI measurements on the resources indicated in the SL CLI configuration, wherein the transceiver is further configured to transmit a report to the second base station indicating the SL CLI measurements.

18. The second UE of claim 17, wherein the resources for performing the SL CLI measurements comprise one of:
time and frequency resources for a sidelink control channel and a sidelink data channel;
time and frequency resources for only a sidelink data channel; or
resources for receiving one or more channel state information reference signals (CSI-RSs).

19. The second UE of claim 17, wherein to perform the SL CLI measurements the at least one processor is further configured to measure a reference signal received power (RSRP) of one or more demodulation reference signals (DMRSs) transmitted on a sidelink control channel by a first UE associated with a first BS.

20. The second UE of claim 17, wherein to perform the SL CLI measurements the at least one processor is further configured to measure a received signal strength indicator (RSSI) on time and frequency resources for at least one of a control channel or a data channel via which a first UE associated with a first BS transmits.

21. The second UE of claim 17, wherein to perform the SL CLI measurements the at least one processor is further configured to:
measure a first reference signal received power (RSRP) of one or more demodulation reference signals (DMRSs) transmitted on a sidelink control channel by a first UE associated with a first BS; and
measure a second RSRP of one or more DMRSs transmitted on a sidelink data channel by the first UE associated with the first BS.

22. The second UE of claim 17, wherein to perform the SL CLI measurements the at least one processor is further configured to measure reference signal received power (RSRP) of one or more channel state information reference signals (CSI-RSs) transmitted by a first UE associated with a first BS.

23. The second UE of claim 17, wherein the transceiver is further configured to transmit signaling to the second BS indicating a capability of the second UE for performing the SL CLI measurements, wherein the capability of the second UE for performing the SL CLI measurements indicates one of:
a capability for performing reference signal received power (RSRP) measurements on demodulation reference signals (DMRSs) transmitted on at least one of a SL control channel or a SL data channel; or
a capability for performing reference signal received power (RSRP) measurements on SL channel state information reference signals (CSI-RSs).

24. The second UE of claim 17, wherein:
the transceiver is further configured to receive at least one of:
a CLI received signal strength indicator (RSSI) configuration indicating resources for performing CLI RSSI measurements associated with the second BS; or
a CLI sounding reference signal (SRS) configuration indicating resources for performing CLI measurements on one or more SRSs associated with the second BS:
at least one of the CLI RS SI configuration or the CLI SRS configuration overlaps the SL CLI configuration; and
the at least one processor is further configured to:
prioritizing, based on the overlap, measurements associated with the CLI RSSI configuration or measurements associated with the CLI SRS configuration over measurements associated with the SL CLI configuration; or
releasing, based on the received SL CLI configuration, at least one of the resources associated with the CLI RSSI configuration or the resources associated with the CLI SRS configuration.

25. The second UE of claim 17, wherein:
the SL CSI configuration further indicates a downlink transmission configuration indicator (TCI) state; and
wherein to perform the SL CLI measurements the at least one processor is further configured to use a receive beam associated with the indicated downlink TCI state.

26. The second UE of claim 17, wherein:
the transceiver is further configured to receive timing information for performing the SL CLI measurements;
the at least one processor is configured to perform the SL CLI measurements are based on the timing information; and
the timing information comprises one of:
a downlink timing advance that is approximately equal to an uplink timing advance used by a first UE for transmissions on the resources used for performing the SL CLI measurements;
a SL timing reference based on a global navigation satellite system (GNSS) time; or
a SL timing reference received from a first UE that has a SL connection with the second UE and wherein the SL CLI configuration includes a source identifier (ID) associated with the first UE.

27. The second UE of claim 17, wherein the at least one processor is configured to perform the SL CLI measurements on the resources indicated in the SL CLI configuration regardless of whether a first UE associated with a first BS is performing one or more SL transmissions on the resources for performing the SL CLI measurements.

28. The second UE of claim 17, wherein:
to perform the SL CLI measurements on the resources indicated in the SL CLI configuration, the at least one processor is further configured to detect a presence or an absence of one or more SL transmissions on the resources; and
to transmit the report to the second base station indicating the SL CLI measurements, the transceiver is further configured to transmit the report to the second base station indicating the SL CLI measurements only when the presence of the one or more SL transmissions on the resources is detected.

29. The second UE of claim 28, wherein:
the at last one processor is configured to detect the absence of the one or more SL transmissions on the resources; and
the transceiver is further configured to transmit an indication of the absence of the one or more SL transmissions on the resources.

30. The second UE of claim 28, wherein the at last one processor is configured to detect the presence of the one or more transmissions on the resources based on at least one of:
successful decoding of the one or more SL transmissions on the resources; or
a reference signal received power (RSRP) or a received signal strength indicator (RSSI) associated with the resources being greater than or equal to a threshold.
